(19) United States
(12) Patent Application Publication
(10) Pub. No.: US 2022/0277358 A1
(43) Pub. Date: Sep. 1, 2022

(54) INFORMATION PROCESSING SYSTEM, INFORMATION PROCESSING METHOD, AND PROGRAM

(71) Applicants: Propre Pte. Ltd., Singapore (SG); Propre Japan Inc., Tokyo (JP)

(72) Inventor: Hisaya Shirai, Singapore (SG)

(21) Appl. No.: 17/597,795

(22) PCT Filed: Jul. 22, 2020
(86) PCT No.: PCT/JP2020/028535

§ 371 Date: Jan. 24, 2022

Related U.S. Application Data
(60) Provisional application No. 62/878,458, filed on Jul. 25, 2019.
(60) Provisional application No. 62/945,449, filed on Dec. 9, 2019.

(51) Int. Cl. G06Q 30/02

(52) U.S. Cl. CPC G06Q 30/0278

(57) ABSTRACT

An object is to provide a user with appropriate information about a unit area price and liquidity of a property in a predetermined region. There are included an identification unit for identifying a first region that is specified by a user; an acquisition unit for acquiring first unit price information indicating a unit area price of a property in the first region, and first liquidity information indicating liquidity of the property; and a display processing unit for causing a display unit to display the first unit price information and the first liquidity information in association with each other.

### TECHNICAL FIELD

The present invention relates to an information processing system, an information processing method, and a program.

### BACKGROUND ART

There is disclosed a property evaluation apparatus for calculating a predicted price of a property (for example, Patent Literature 1).

### CITATION LIST

### Patent Literature

Patent Literature 1
Japanese Patent Laid-Open No. 2001-117973

### SUMMARY OF INVENTION

### Technical Problem

The property evaluation apparatus described in Patent Literature 1 includes a price evaluation model for calculating a predicted price of a property that is an evaluation target, based on property piece data that is input. The price evaluation model is created based on property piece attribute information (traffic convenience, level of maintenance of property, equipment and specifications of property, etc.), for each segment including one or a plurality of areas for which a degree of similarity is calculated. Moreover, the property evaluation apparatus accumulates record of past sale information of properties, and optimizes the price evaluation model based on the record of the sale information.

However, the property evaluation apparatus described in Patent Literature 1 calculates the predicted price of a single property based on property piece data that is input, and sufficient information is possibly not provided to a user regarding an area price and liquidity in an area including a plurality of properties.

Accordingly, to solve the problem described above, an object of the present invention is to provide, to a user, appropriate information regarding a unit area price and liquidity of a property in a predetermined area.

### Solution to Problem

An information processing system according to an aspect of the present invention includes: an identification unit for identifying a first region that is specified by a user; an acquisition unit for acquiring first unit price information indicating a unit area price of a property in the first region, and first liquidity information indicating liquidity of the property; and a display processing unit for causing a display unit to display the first unit price information and the first liquidity information in association with each other.

An information processing method according to an aspect of the present invention includes: identifying a first region that is specified by a user; acquiring first unit price information indicating a unit area price of a property in the first region, and first liquidity information indicating liquidity of the property; and causing a display unit to display the first unit price information and the first liquidity information in association with each other.

A program according to an aspect of the present invention causes a computer to: identify a first region that is specified by a user; acquire first unit price information indicating a unit area price of a property in the first region, and first liquidity information indicating liquidity of the property; and cause a display unit to display the first unit price information and the first liquidity information in association with each other.

### Advantageous Effect of Invention

According to the present invention, appropriate information regarding a unit area price and liquidity of a property in a predetermined region may be provided to a user.

### BRIEF DESCRIPTION OF DRAWINGS

FIG. 1 is a diagram showing an example of a system configuration of a property system according to an embodiment of the present disclosure.

FIG. 2 is a diagram showing an outline of processes by a property system according to a first embodiment.

FIG. 3 is a diagram showing an example of a functional configuration of a server according to the first embodiment.

FIG. 4 is a diagram showing an example of property index information.

FIG. 5 is a diagram showing an example of an input image according to the first embodiment.

FIG. 6 is a diagram showing an example of a color-coded list according to the first embodiment.

FIG. 7 is a diagram showing an example of a comparison image according to the first embodiment.

FIG. 8 is a diagram showing an example of a city-to-city comparison image according to the first embodiment.

FIG. 9 is a diagram showing an example of the configuration of a user terminal according to the first embodiment.

FIG. 10 is a flowchart showing a procedure of information processing by the property system according to the first embodiment.

FIG. 11 is a diagram showing a configuration of the server according to a first modification of the first embodiment.

FIG. 12 is a diagram showing an example of property feature information.

FIG. 13 is a diagram showing an example of an input image according to the first modification of the first embodiment.

FIG. 14 is a diagram showing an example of a feature comparison image according to the first modification of the first embodiment.

FIG. 15 is a flowchart showing a procedure of information processing by the property system according to the first modification of the first embodiment.

FIG. 16 is a diagram showing a feature comparison image that is generated by the server according to a second modification of the first embodiment.

FIG. 17 is a diagram showing an example of a functional configuration of the server according to a second embodiment.

FIG. 18 is a diagram showing an example of an input image according to the second embodiment.

FIG. 19 is a diagram showing an example of a transition image according to the second embodiment.

FIG. 20 is a flowchart showing a procedure of information processing by the property system according to the second embodiment.

FIG. 21 is a diagram showing an example of a transition image according to a modification of the second embodiment.

FIG. 22 is a diagram showing an example of a functional configuration of the server according to a third embodiment.

FIG. 23 is a diagram showing an example of an input image according to the third embodiment.

FIG. 24 is a diagram showing an example of a feature-related image according to the third embodiment.

FIG. 25 is a diagram showing another example of the input image according to the third embodiment.

FIG. 26 is a flowchart showing a procedure of information processing by the property system according to the third embodiment.

FIG. 27 is a diagram showing an example of a functional configuration of the server according to a fourth embodiment.

FIG. 28 is a diagram conceptually showing a first index and a second index on the transition image in FIG. 19.

FIG. 29 is a diagram showing an example of an index image according to the fourth embodiment.

FIG. 30 is a flowchart showing a procedure of information processing by the property system according to the fourth embodiment.

### DESCRIPTION OF EMBODIMENTS

Hereinafter, a property system 10 according to an embodiment of the present invention will be described in detail with reference to the drawings. However, embodiments described below are merely examples, and are not intended to exclude various modifications and technical applications that are not explicitly described below. That is, the present invention may be carried out by being modified in various ways without departing from the spirit of the invention, or by combining the embodiments. Moreover, when describing the drawings, same or similar parts are denoted by same or similar reference signs.

===Configuration of Property System 10===

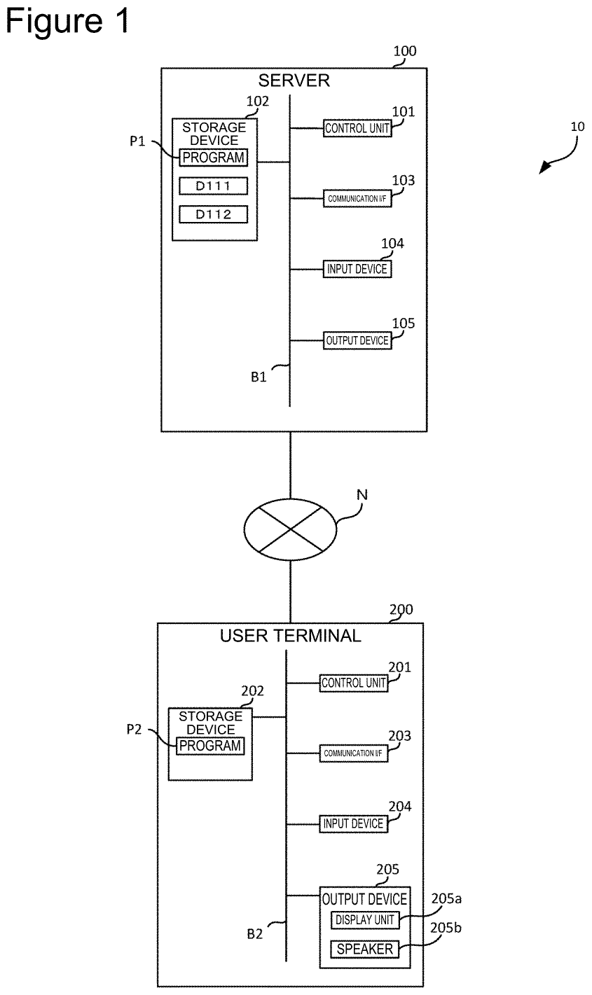

FIG. 1 is a diagram showing a configuration of a property system 10 according to an embodiment of the present disclosure. As disclosed in FIG. 1, in the property system 10, a server 100 and a user terminal 200 are connected over a network N. The server 100 provides a service of providing various pieces of information to a plurality of user terminals 200 over the network N. Additionally, the numbers of the servers 100 and the user terminals 200 connected to the network N are not limited.

The network N serves to connect at least one server 100 and the user terminal 200. That is, the network N refers to a communication network that provides a connection path for transmission/reception of data after the user terminal 200 is connected to the server 100. One or more parts of the network N may, but not necessarily, be a wired network or a wireless network.

The server 100 includes a function of providing a predetermined service to the user terminal 200. The server 100 may be any apparatus as long as it is an information processing apparatus that is capable of providing functions described in the embodiments. The server 100 may be, but not limited to, a server computer, a personal computer (such as, but not limited to, a desktop, a laptop or a tablet), a media computer platform (such as, but not limited to, a cable, a satellite set-top box or a digital video recorder), a hand-held computer device (such as, but not limited to, a PDA or an email client), other types of computers or communication platforms. The server 100 may be referred to as an information processing apparatus.

The user terminal 200 may be any information processing apparatus as long as it is an information processing apparatus (a computer) that is capable of providing functions described in the embodiments. The user terminal 200 may be, but not limited to, a smartphone, a mobile phone (a feature phone), a personal computer (such as, but not limited to, a desktop, a laptop or a tablet), a media computer platform (such as, but not limited to, a cable, a satellite set-top box or a digital video recorder), a hand-held computer device (such as, but not limited to, a personal digital assistant (PDA) or an email client), a wearable terminal (such as a glass device or a watch device), other types of computers or communication platforms. The user terminal 200 may be referred to as an information processing apparatus.

<<Hardware (HW) Configuration>>

A HW configuration of each apparatus included in the property system 10 will be described with reference to FIG. 1.

The server 100 includes a control unit (CPU) 101, a storage device 102, a communication I/F (interface) 103, an input device 104, and an output device 105. The structural elements of the HW of the server 100 are, but not limited to, interconnected by a bus B1. Additionally, the HW of the server 100 does not necessarily have to include all the structural elements as components of the HW of the server 100. For example, with the HW of the server 100, the output device 105 may be or may not necessarily be removable.

The control unit 101 includes a physical circuit for executing a function that is implemented by a code or a command in a program, and, but not limited to, is implemented by a data processing device that is embedded in hardware, for example.

The control unit 101 is typically a central processing unit (CPU), but may alternatively be a microprocessor, a processor core, a multiprocessor, an ASIC, an FPGA or the like. In the present disclosure, the control unit 101 is not limited to those mentioned above.

The storage device 102 includes a function of storing various programs and various pieces of data that are necessary for operation of the server 100. The storage device 102 is implemented by various storage media including an HDD, an SSD and a flash memory. However, in the present disclosure, the storage device 102 is not limited to those mentioned above. The storage device 102 may, but not necessarily, be referred to as a memory.

The communication I/F 103 performs transmission/reception of various pieces of data over the network N. Communication by the communication I/F 103 may be performed in a wired or wireless manner, and any communication protocol may be used as long as mutual communication may be performed. The communication I/F 103 includes a function of performing communication with other apparatuses such as the user terminal 200 over the network N. The communication I/F 103 transmits various pieces of data to other apparatuses according to an instruction from the control unit 101. Furthermore, the communication I/F 103 receives various pieces of data transmitted from other apparatuses, and transfers the same to the control unit 101. The communication I/F 103 may sometimes be simply referred to as a communication unit. Moreover, in the case where the communication I/F 103 is a physical circuit, a term “communication circuit” may also be used.

The input device 104 is implemented by a device for inputting various operations for the server 100. The input device 104 is implemented by one or a combination of any types of devices that are capable of receiving input from a user and of transferring information based on the received input to the control unit 101. The input device 104 is typically implemented by hardware keys typified by a keyboard, or a pointing device such as a mouse. Additionally, the input device 104 may, but not necessarily, include, but not limited to, a touch panel or a camera (operation input through moving images), or a microphone (operation input through sound). In the present disclosure, the input device 104 is not limited to those mentioned above.

The output device 105 includes, but is not limited to, a display unit 13a. The display unit 13a is typically implemented by a monitor (such as, but not limited to, a liquid crystal display or an OELD). Additionally, the display unit 13a may, but is not limited to, be a head mounted display (HDM). The display unit 13a may, but not necessarily, be capable of displaying display data in 3D. Additionally, in the present disclosure, the display unit 13a is not limited to those mentioned above.

The server 100 stores a program P1 and databases D111, D112 in the storage device 102. With the server 100, a process of each unit included in the control unit 101 is performed when the control unit 101 executes the program P1. That is, the program 15a stored in the storage device 102 causes the server 100 to provide each function that is performed by the control unit 101. This program P1 may, but not necessarily, be referred to as a program module.

The user terminal 200 includes a control unit (CPU: central processing unit) 201, a storage device 202, a communication I/F (interface) 203, an input device 204, and an output device 205. Structural elements of HW of the user terminal 200 are, but not limited to, interconnected by a bus B2. Additionally, the HW of the user terminal 200 does not necessarily have to include all the structural elements. For example, with the user terminal 200, each structural element, such as the input device 204, the output device 205 and the like, or a plurality of structural elements may be or may not necessarily be removable.

The communication I/F 203 performs transmission/reception of various pieces of data over the network N. Communication by the communication I/F 203 may be performed in a wired or wireless manner, and any communication protocol may be used as long as communication may be performed. The communication I/F 203 includes a function of performing communication with the server 100 over the network N. The communication I/F 203 transmits various pieces of data to the server 100 according to an instruction from the control unit 201. Furthermore, the communication I/F 203 receives various pieces of data transmitted from the server 100, and transfers the same to the control unit 201. The communication I/F 203 may sometimes be simply referred to as a communication unit. Moreover, in the case where the communication I/F 203 is a physical circuit, a term “communication circuit” may also be used.

The input device 204 includes a device for inputting various operations for the user terminal 200. The output device 205 includes a device for outputting a processing result obtained by processing by the user terminal 200. The input device 204 and the output device 205 may be, but not necessarily, identified as an input/output unit. In the case of being an input/output unit, the input device 204 and the output device 205, as the input/output unit, may be integrated or separated from each other.

The input device 204 is implemented by one or a combination of any types of devices that are capable of receiving input from a user and of transferring information based on the received input to the control unit 201. The input device 204 includes, but is not limited to, an operation unit 22a, a microphone 22b, and a camera 22c. The operation unit 22a includes, but is not limited to, a touch panel, a touch display, hardware keys such as a keyboard, or a pointing device such as a mouse. The microphone 22b includes, but is not limited to, a device to which sound is input. The microphone 22b is used for input of audio data. The camera 22c includes, but is not limited to, a device for inputting an image. The camera 22c is used to acquire image data.

The output device 205 is implemented by one or a combination of any types of devices that are capable of outputting a processing result obtained by processing by the control unit 201. The output device 205 includes, but is not limited to, a display unit 205a and a speaker (audio output) 23b. Furthermore, the output device 205 includes, but is not limited to, a touch panel, a touch display, a lens (for example, 3D (three dimensions) output or hologram output), a printer and the like.

The display unit 205a is implemented by one or a combination of any types of devices that are capable of displaying an image based on display data written in a frame buffer. The display unit 205a includes, but is not limited to, a touch panel, a touch display, a monitor (such as, but not limited to, a liquid crystal display or an organic electroluminescence display (OELD)), a head mounted display (HDM), projection mapping, a hologram, or a device that is capable of displaying images, text information and the like in the air (vacuum or otherwise). The display unit 205a may, but not necessarily, be capable of displaying display data in 3D. The speaker 205b is used for output of audio data.

The input device 204 and the output device 205 may be, but not limited to, identified as an input/output unit, and may be configured as a touch panel. In the case where the input device 204 and the output device 205 are configured as a touch panel, the operation unit 22a and the display unit 205a having approximately same shapes and sizes may be disposed facing each other.

The control unit 201 includes a physical circuit for executing a function that is implemented by a code or a command in a program, and, but not limited to, is implemented by a data processing device that is embedded in hardware, for example. Accordingly, the control unit 201 may, but not necessarily, be referred to as a control circuit.

The control unit 201 may include, but not limited to, a central processing unit (CPU), a microprocessor, a processor core, a multiprocessor, an application-specific integrated circuit (ASIC), or a field programmable gate array (FPGA).

The storage device 202 includes a function of storing various programs and various pieces of data that are necessary for operation of the user terminal 200. The storage device 202 includes, but is not limited to, various storage media such as a hard disk drive (HDD), a solid state drive (SSD), a flash memory, a random access memory (RAM), and a read only memory (ROM). The storage device 202 may, but not necessarily, be referred to as a memory.

The user terminal 200 stores a program P2 and a database in the storage device 202. With the user terminal 200, a process of each unit included in the control unit 201 is performed when the control unit 201 executes the program P2. That is, the program P2 stored in the storage device 202 causes the user terminal 200 to provide each function that is performed by the control unit 201. This program P2 may, but not necessarily, be referred to as a program module.

Each embodiment of the present disclosure will be described to be implemented through execution of a program by the CPU of the user terminal 200 and/or the server 100.

Furthermore, the program (such as, but not limited to, a software program, a computer program, or a program module) in each embodiment of the present disclosure may, but not necessarily, be provided by being stored in a computer-readable storage medium. The storage medium is capable of storing the program in each embodiment in a “non-transitory tangible medium”. Furthermore, the program in each embodiment may, but not necessarily, be for providing a part of the functions in each embodiment of the present disclosure. Furthermore, a so-called difference file (a difference program) that allows the function in each embodiment of the present disclosure to be implemented, by being combined with a program that is already recorded in the storage medium, may, but not necessarily, be included.

The storage medium may include one or more semiconductor-based or other integrated circuits (ICs) (such as, but not limited to, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid state drives (SSDs), RAM-drives, secure digital cards or drives, any other suitable storage media, or any suitable combination of two or more of the above. The storage medium may be volatile, non-volatile, or a combination of volatile and non-volatile, where appropriate. Additionally, the storage medium is not limited to the examples mentioned above, and may be any device or medium as long as the program P may be stored therein. The storage medium may, but not necessarily, be referred to as a memory.

The server 100 and/or the user terminal 200 may provide functions of a plurality of functional units indicated in each embodiment by reading out programs stored in the storage medium and executing the programs that are read out.

The program in the present disclosure may, but not necessarily, be provided to the server 100 and/or the user terminal 200 through any transmission medium (such as a communication network or broadcast waves) that is capable of transmitting the program. For example, the server 100 and/or the user terminal 200, but not limited to, provides the functions of a plurality of functional units indicated in each embodiment by executing the program P that is downloaded via the Internet or the like.

Furthermore, each embodiment of the present disclosure may be implemented in the form of a data signal embedded in a carrier wave, where the program is embodied by electronic transmission. Processes by the server 100 and/or the user terminal 200 may, but not necessarily, be at least partially implemented by one or more computers (such as, but not limited to, cloud computing including one or more computers).

Processes by the user terminal 200 may, but not necessarily, be at least partially performed by the server 100. In this case, processes by the functional units in the control unit 201 of the user terminal 200 may, but not necessarily, be at least partially performed by the server 100.

Processes by the server 100 may, but not necessarily, be at least partially performed by the user terminal 200. In this case, processes by the functional units in the control unit 101 of the server 100 may, but not necessarily, be at least partially performed by the user terminal 200.

Unless explicitly stated, the configuration for determination in the embodiments of the present disclosure is not essential, and a predetermined process may be performed when a determination condition is satisfied, a predetermined process may be performed when a determination condition is not satisfied, or a predetermined process may be performed otherwise.

Additionally, the programs of the present disclosure are implemented using, but not limited to, PHP, Python, Java (registered trademark), JavaScript (registered trademark), a programming language such as Objective-C, Swift or C++, or a markup language such as hyper text markup language (HTML) 5.

The storage device 102 of the server 100 stores pieces of information that are used in various processes, for example. The pieces of information include, but are not limited to, property index information D111 (date/time, property ID, location, sale price, rental price, liquidity index, area), and property feature information D112 (property ID, features 1 to n). Additionally, details of the property index information D111 and the property feature information D112 will be given later.

### First Embodiment

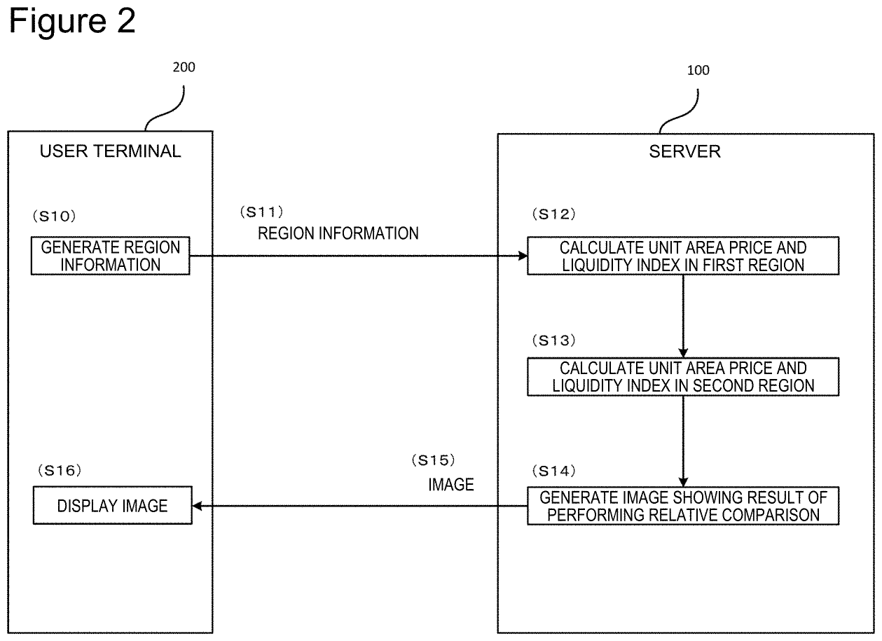

An outline of the property system 10 according to a first embodiment will be given with reference to FIGS. 1 and 2. FIG. 2 is a diagram showing an outline of processes by the property system 10.

As shown in FIG. 1, the property system 10 includes the server 100 and the user terminal 200, for example. The server 100 identifies a region that is specified by an input from a user on the user terminal 200, for example. The server 100 generates information indicating a unit area price of a property (hereinafter “unit price information”) and information indicating an index of liquidity of the property (hereinafter “liquidity index”; the information will be hereinafter referred to as “liquidity information”) in relation to the specified region, for example. The property system 10 causes the display unit 205a of the user terminal 200 to display the generated unit price information and the generated liquidity information in association with each other.

The “specified region” refers to a region, in map data displayed on the display unit 205a of the user terminal 20, that is specified by input of an operation on the user terminal 20 by a user, for example.

The “unit area price” of a property is an index indicating at least one of a sale price or a rent of the property per unit area, for example. Furthermore, the “unit area price” of a property is not limited to the sale price or the rent, as long as it is an index indicating a value of the property per unit area, for example. In relation to the property system 10, the sale price of a property will be described below to be the unit area price of the property for the sake of convenience.

The “liquidity index” of a property is an index indicating the ease with which the property can be converted into cash, for example. The ease with which a property can be converted into cash includes the ease of sale, the ease of rental and the like, for example. Additionally, in the following, the liquidity index may sometimes be referred to as “liquidity”.

Next, an outline of the processes by the property system 10 will be described with reference to FIG. 2. First, in S10, the user terminal 200 receives input of an operation from a user, and generates information about a specified region (hereinafter “region information”), for example. The specified region includes a region as a benchmark, and a region to be compared with the region as the benchmark, for example. In S11, the user terminal 200 transmits the region information to the server 100.

Next, in S12, the server 100 calculates, based on the region information, the unit area price and the liquidity index for the region as the benchmark (hereinafter “first region”), for example. Then, the server 100 generates, for the first region, the unit price information indicating the unit area price (hereinafter “first unit price information”) and the liquidity information indicating the liquidity index (hereinafter “first liquidity information”).

Next, in S13, the server 100 may identify, based on the region information, the unit area price and the liquidity index for a region (hereinafter “comparison region”) to be compared with the first region, for example. Then, the server 100 calculates the unit area price and the liquidity index for a predetermined segmented region (hereinafter “second region”) included in the comparison region, for example. Then, the server 100 generates, for the second region, the unit price information (hereinafter “second unit price information”) and the liquidity information (hereinafter “second liquidity information)”, for example.

Next, in S14, the server 100 compares the first unit price information and the first liquidity information with the second unit price information and the second liquidity information, for example. The server 100 generates an image that displays, in a visually easily understandable manner, results for the second unit price information and the second liquidity information, relative to the first unit price information and the first liquidity information, or data for image display (for example, text data such as HTML) for causing the image mentioned above to be displayed on the display unit 205a of the user terminal 200, for example. In the following, the image and the data for image display will be referred to as “image”. That is, when a description “generate an image (including an object included in the image)” is given, this includes generation of the image, and may include generation of the data for image display, for example. Furthermore, when a description “the server 100 transmits the image to the user terminal 200” is given, this includes transmission of the image from the server 100 to the user terminal 200, and may include transmission of the data for image display from the server 100 to a browser on the user terminal 200 side, for example.

Next, in S15, the server 100 transmits the generated image to the user terminal 200. In S16, the user terminal 200 causes the image to be displayed on the display unit 205a.

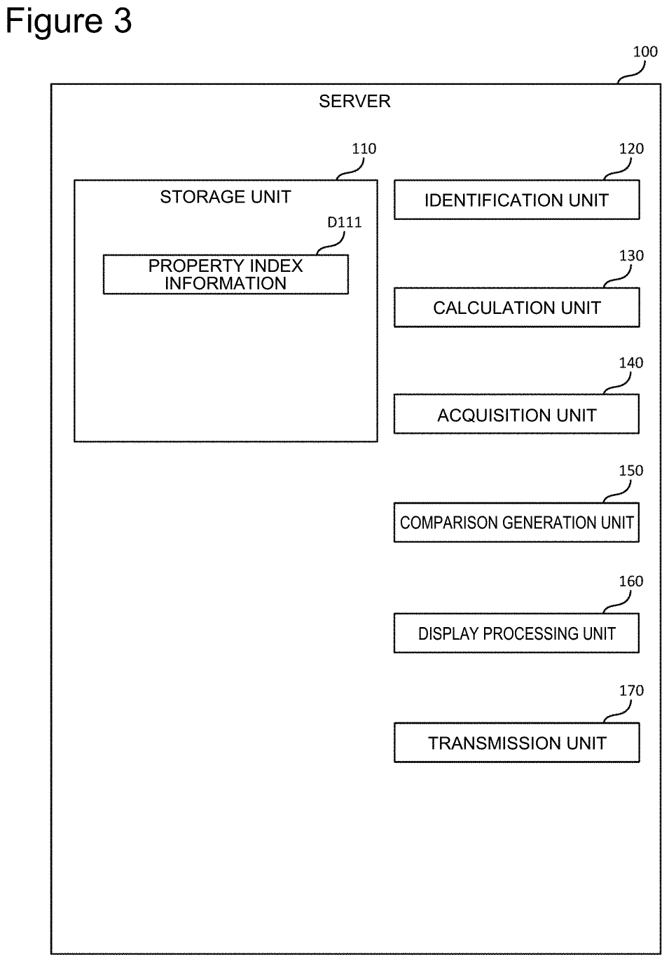

In the following, a functional configuration of the server 100 will be described with reference to FIG. 3. FIG. 3 is a diagram showing an example of the functional configuration of the server 100 according to the first embodiment. For example, the server 100 transmits, to the user terminal 200, an image including a result of comparison of the first unit price information and the first liquidity information for the first region with the second unit price information and the second liquidity information for the second region. For example, the server 100 includes functional units including a storage unit 110, an identification unit 120, a calculation unit 130, an acquisition unit 140, a comparison generation unit 150, a display processing unit 160, and a transmission unit 170.

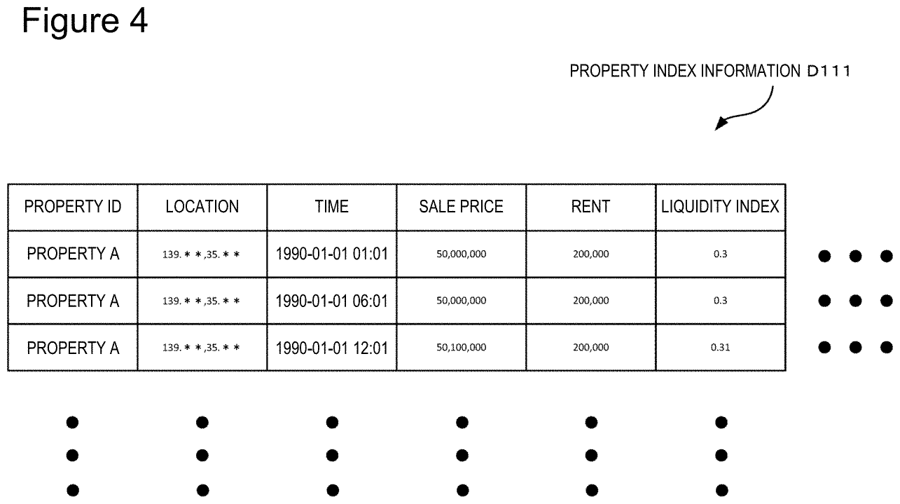

The storage unit 110 includes the property index information D111, for example. FIG. 4 is a diagram showing an example of the property index information D111. As shown in FIG. 4, the property index D111 includes the following items, for example: property ID, location, time, sale price, rent, and liquidity index.

“Property ID” is an item including a property ID that is an identification code of a property. For example, the property ID is a code that is assigned to each property, and is attached to a property that is newly posted on the Internet.

“Location” is an item that is associated with the item “property ID”, and that includes latitude/longitude indicating a location, for example.

“Time” is an item that is associated with the item “property ID”, and that includes year/month/day/hour/minute, for example.

“Sale price” is an item that is associated with the items “property ID” and “time”, and that includes a sale price of a property at the time of buying/selling the property, for example.

“Rent” is an item that is associated with the items “property ID” and “time”, and that includes a rental price of a property at the time of rental of the property, for example.

“Liquidity index” is an item that is associated with the items “property ID” and “time”, and that includes a liquidity index indicating the liquidity of a property, for example.

Additionally, the property index information D111 stored in the storage unit 110 does not have to be stored in the server 100, and may be stored in an apparatus different from the server 100, for example. In this case, the server 100 may acquire the property index information D111 from such an apparatus.

For example, the identification unit 120 identifies a first region (for example, Roppongi Station) that is specified by input of an operation on the user terminal 200 by a user, for example. The first region may be specified using a lot number or may be specified using the name of a property, for example. Furthermore, the first region may be a region on an image that is displayed on the display unit 205a of the user terminal 200 when a predetermined enter button (a first region determination section T24 described later) is selected by the user.

Moreover, the identification unit 120 identifies a comparison region, for example. The comparison region may be a region that is specified by input of an operation on the user terminal 200 by the user (such as within a radius of 1 km of the first region), or may be a region that is automatically set according to a condition that is determined in advance in relation to the first region. Furthermore, the comparison region may be a region having a predetermined size and surrounding the first region, or may be a region having a predetermined size and not in contact with the first region (for example, in a district or a country different from the first region), for example. Furthermore, the comparison region may be a region displayed on the display unit 205a of the user terminal 200, for example.

Furthermore, the identification unit 120 identifies a second region included in the comparison region. The second region is a region having a predetermined shape arranged in the comparison region, for example. Specifically, the second region may be a region that is arranged in a honeycomb arrangement, for example. In the case where the second region is in a honeycomb arrangement, second regions may be tightly arranged in the comparison region. Furthermore, when zooming in or out on the comparison region displayed on the display unit 205a, the second region may be smoothly displayed, and a processing speed of a display process on the display unit 205a may be increased.

The calculation unit 130 calculates the unit area price and the liquidity index for a region (the first region, the second region, the comparison region or the like) that is identified by the identification unit 120, for example. The calculation unit 130 calculates the unit area price by dividing the sale price or the rent of a property included in the region by the area, for example. Furthermore, the calculation unit 130 calculates an average value of the liquidity index of properties included in the region, as the liquidity index for the region, for example. Moreover, the calculation unit 130 may perform the calculation while excluding a specific index based on a statistical method, or while excluding one that can be evaluated to be the same property, for example. Furthermore, the calculation unit 130 may calculate the unit area price in a predetermined region through estimation based on the unit area price in another region different from the predetermined region, for example. Specifically, in the case where there are many properties around station A and intersection B and not many properties around location C near station A and intersection B, the calculation unit 130 may calculate an average of the unit area price in the region including station A and the unit area price in the region including intersection B as the unit area price in the region including location C, for example. The calculation unit 130 may also calculate the liquidity index for a predetermined region in the same manner as for the unit area price, for example. The calculation unit 130 causes the unit area price and the liquidity index for the region to be stored in the storage unit 110, for example.

The acquisition unit 140 acquires, from the storage unit 110, various pieces of information including the first unit price information, the first liquidity information, the second unit price information, and the second liquidity information, for example. Additionally, the acquisition unit 140 may acquire various pieces of information from apparatuses different from the user terminal 200 and the server 100, for example.

The comparison generation unit 150 generates relative information indicating a result of relatively comparing the first unit price information and the first liquidity information for the first region with the second unit price information and the second liquidity information for the second region, for example. Specifically, for example, the comparison generation unit 150 calculates relative indices in relation to the second unit price information and the second liquidity information by taking the first unit price information and the first liquidity information as benchmarks. For example, in the case where the unit area price indicated by the first unit price information is “100”, the liquidity index indicated by the first liquidity information is “100”, the unit area price indicated by the second unit price information is “200”, and the liquidity index indicated by the second liquidity information is “150”, the comparison generation unit 150 may calculate “2” for the unit area price of property and “1.5” for the liquidity index and thereby generate relative information for the second region. Furthermore, the comparison generation unit 150 may calculate relative indices for the second region based on minimum values and maximum values of the unit area price indicated by the first unit price information and the liquidity index indicated by the first liquidity information, for example. Specifically, for example, in the case where, in relation to the first region, the maximum value and the minimum value of the unit area price are “300” and “200”, and the maximum value and the minimum value of the liquidity index are “200” and “250”, the comparison generation unit 150 calculates the average value of the unit area price to be “250” and the average value of the liquidity index to be “225”. In the same manner, in the case where, in relation to the second region, the maximum value and the minimum value of the unit area price are “400” and “200”, and the maximum value and the minimum value of the liquidity index are “300” and “260”, the comparison generation unit 150 calculates the average value of the unit area price to be “300” and the average value of the liquidity index to be “280”. The relative indices for the second region relative to the first region may be calculated by comparing the average value of the unit area price and the average value of the liquidity index in the first region with the average value of the unit area price and the average value of the liquidity index in the second region. That is, a calculation method is not limited as long as the comparison generation unit 150 may calculate indices based on relative comparison of the unit area price and the liquidity index in the second region with the unit area price and the liquidity index in the first region, and may generate the relative information.

Furthermore, at the time of generating the relative information, the comparison generation unit 150 matches units of the unit area price and of the liquidity index between the first region and the second region, for example. Specifically, for example, in the case where the first region is a predetermined region in Japan and the second region is a predetermined region in the USA, the comparison generation unit 150 uses “yen” as the unit of the unit area price and “hour/minute” as the time based on which the liquidity index is calculated. The first region may thus be relatively compared with any region around the world.

Furthermore, the comparison generation unit 150 may virtually generate the second unit price information and the second liquidity information for a second region where the second unit price information and the second liquidity information cannot be collected, based on the second unit price information and the second liquidity information for a second region where such pieces of information can be collected, by using a linear interpolation method, for example. A processing speed for generating an image may thus be increased while reducing the amount of calculation by the server 100.

The display processing unit 160 generates an image in which the unit price information and the liquidity information are associated with each other, for example. In the present embodiment, the display processing unit 160 generates an object indicating the relative information (hereinafter “first object”), for example. The first object is an object that displays, in a manner that can be easily visually grasped by the user, the second unit price information and the second liquidity information relative to the first unit price information and the first liquidity information, for example. The display processing unit 160 may generate the first object while changing its color according to divergences between the unit area price indicated by the first unit price information and the liquidity index indicated by the first liquidity information, and the unit area price indicated by the second unit price information and the liquidity index indicated by the second liquidity information, for example. The display processing unit 160 generates the first object while causing the same to overlap the second region in a display region, for example. Additionally, the display processing unit 160 may generate the first object while changing its shape, line type or the like according to the divergences, for example. In the following, the display processing unit 160 is assumed to generate the first object whose color is changed according to the divergences, for the sake of convenience.

Next, various images that are generated by the display processing unit 160 will be described. For example, the display processing unit 160 generates an input image T1 used by the user to input various pieces of information, a color-coded list TL showing an example display of the relative information, a comparison image T2 showing an image comparing the unit price information and the liquidity information between the first region and the second region, and a city-to-city comparison image T3 displaying a plurality of regions next to one another.

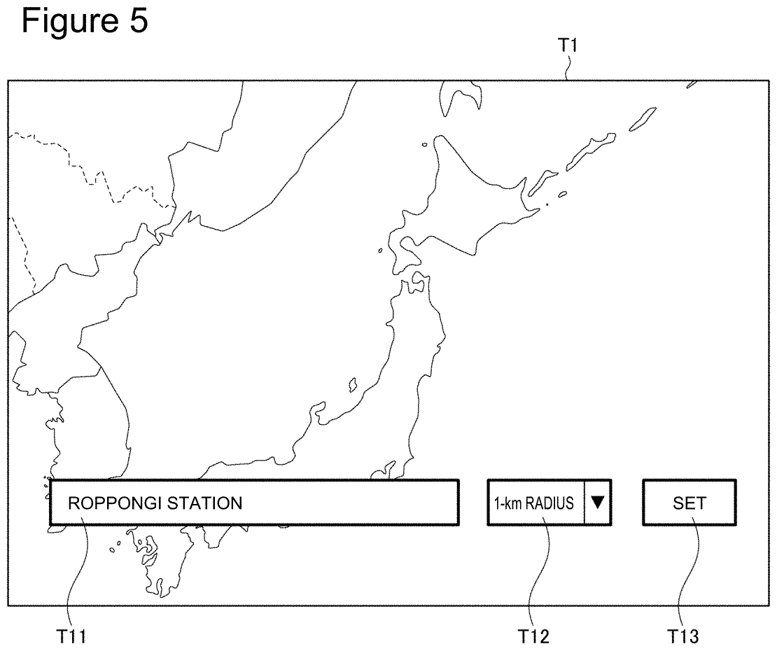

FIG. 5 is a diagram showing an example of the input image T1. As shown in FIG. 5, the input image T1 includes at least a setting section T11, a region setting section T12, and a setting confirmation section T13, for example. The setting section T11 is an object used to specify a region to be the first region, and may be a text box, for example. Additionally, the setting section T11 may be configured such that the first region is set by a pull-down menu, for example. The region setting section T12 is a part used to specify a region to be the comparison region, and may be configured such that the comparison region is specified by a pull-down menu, for example. The region setting section T12 may be a text box used to specify the country or the lot number, for example. The setting confirmation section T13 is a button used to fix region information about the first region and the comparison region in the case where input thereto of an operation by the user is received on the user terminal 200, for example.

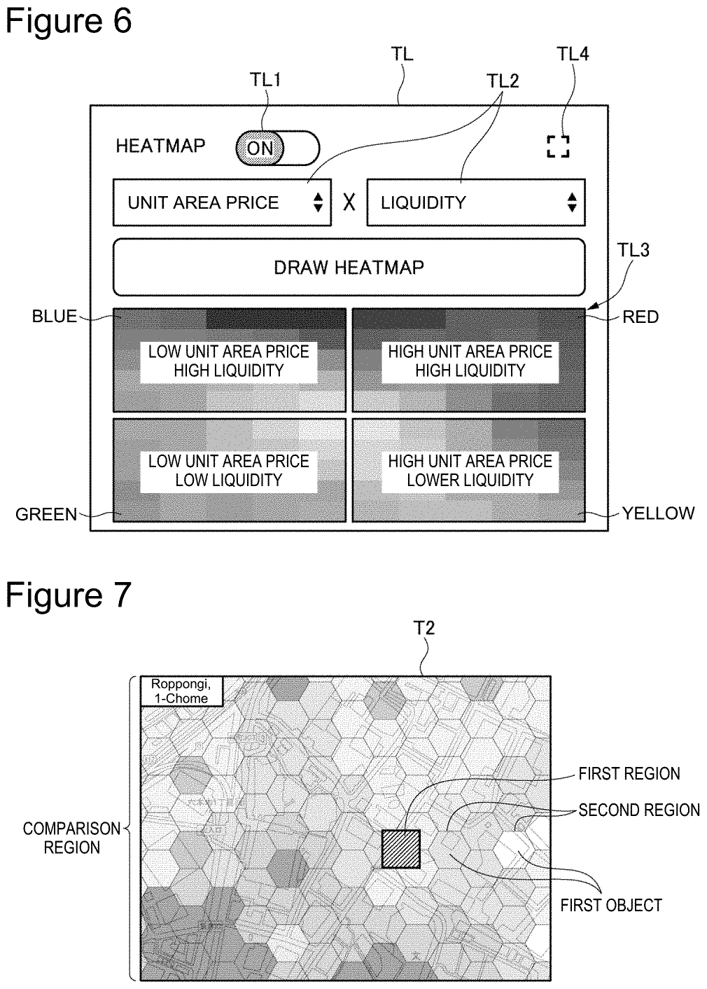

FIG. 6 is a diagram showing an example of the color-coded list TL. As shown in FIG. 6, the color-coded list TL includes at least a relative display switching section TL1, index selection sections TL2, a color-coded display section TL3, and a first region determination section TL4, for example. The relative display switching section TL1 is a button used to switch between whether color-coding is to be used or not for relative comparison with the first region, for example. The index selection sections TL2 are objects for selectively switching among relative comparison based on a combination of unit area price and liquidity, relative comparison based only on the unit area price, and relative comparison based only on the liquidity, for example. In FIG. 6, relative comparison is set to be performed based on the combination of unit area price and liquidity. For example, the color-coded display section TL3 is an object indicating example color-coding of each index based on information that is set in the index selection sections TL2. For example, in FIG. 6, color-coding is performed such that the higher on the page, the higher the liquidity, the lower on the page, the lower the liquidity, the more rightward on the page, the higher the unit area price, and the more leftward on the page, the lower the unit area price. The first region determination section TL4 is a button for setting the region displayed on the display unit 205a as the first region when there is input thereto of an operation by the user on the user terminal 200, for example. That is, the first region may be a region that is input in the text box of the setting section T11, or may be a region that is displayed on the display unit 205a when the first region determination section TL4 is selected, for example. Additionally, the color-coded list TL may be an image that is displayed superimposed on an image of the comparison image T2 described later, for example.

FIG. 7 is a diagram showing an example of the comparison image T2. As shown in FIG. 7, the comparison image T2 includes, in the comparison region, an object indicating the first region and the first objects superimposed on the second regions. The user may thereby visually grasp relative indices regarding the unit area price and the liquidity in each second region relative to the unit area price and the liquidity index in the first region.

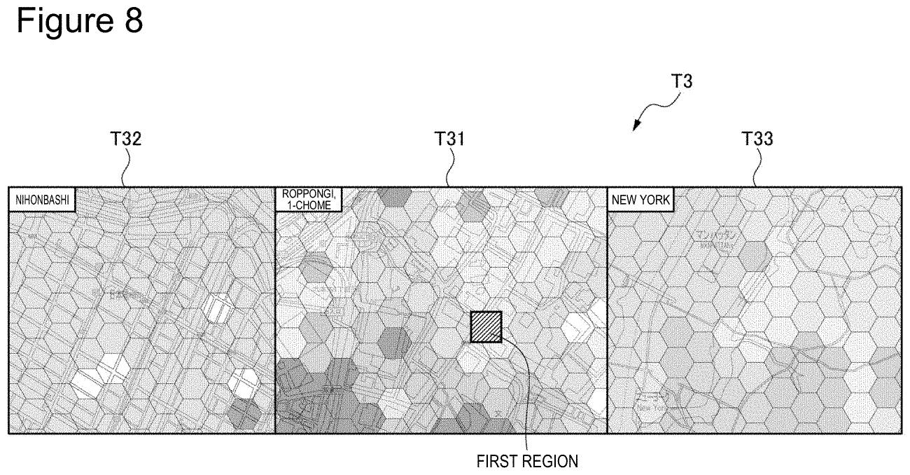

FIG. 8 is a diagram showing an example of the city-to-city comparison image T3. As shown in FIG. 8, the city-to-city comparison image T3 includes a first comparison region image T31 including a first comparison region including the first region, a second comparison region image T32 including a region different from the first comparison region, and a third comparison region image T33 including a region different from the first and second comparison regions, for example. Each image includes the first objects indicating comparison information obtained by comparison relative to the unit area price and the liquidity index in the first region, for example. Accordingly, a plurality of different regions may be relatively compared using the first region as the benchmark, and convenience of the user may be increased. Additionally, in FIG. 8, images indicating three different regions are arranged next to one another, but the number of images to be arranged and the manner of arrangement are not limited thereto.

The transmission unit 170 transmits various images to the user terminal 200, for example.

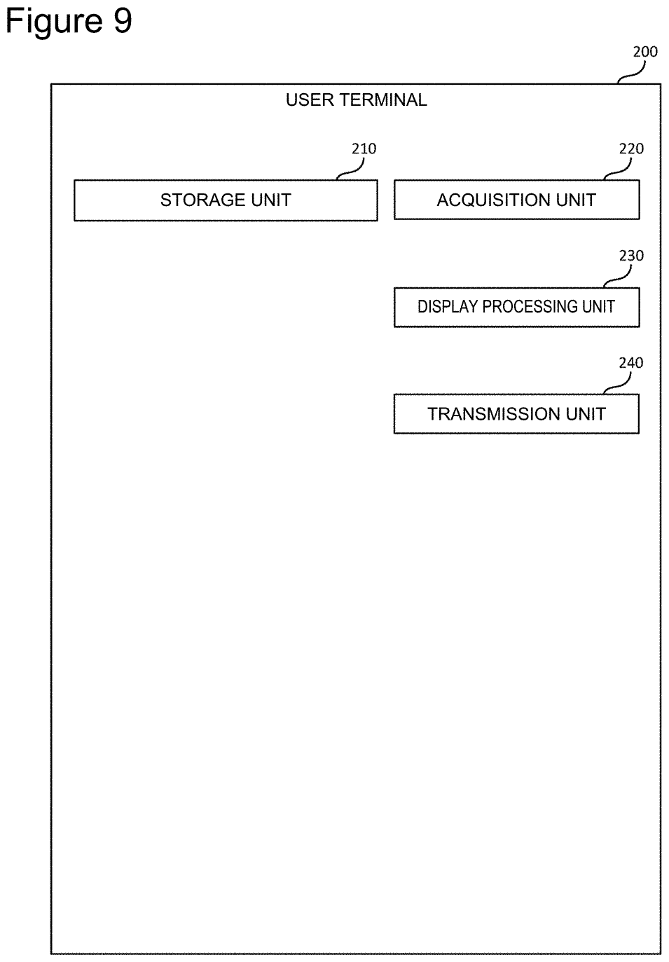

Next, a functional configuration of the user terminal 200 will be described with reference to FIG. 9. FIG. 9 is a diagram showing an example of the configuration of the user terminal 200 according to the first embodiment. For example, the user terminal 200 causes the display unit 205a to display an image indicating a relation between the unit price information and the liquidity information for a predetermined region, based on information acquired from the server 100. This allows the user to grasp, using the user terminal 200, the manner of change in the price and liquidity of property in a predetermined region, and to make an appropriate investment in property.

The user terminal 200 includes functional units including a storage unit 210, an acquisition unit 220, a display processing unit 230, and a transmission unit 240, for example. The storage unit 210 stores various pieces of information, for example. The acquisition unit 220 acquires various pieces of information from the server 100 or other apparatuses, for example. The display processing unit 230 causes various pieces of information (such as images) that are acquired, to be displayed on the display unit 205a, for example. The transmission unit 240 transmits various pieces of information to the server 100 and other apparatuses, for example.

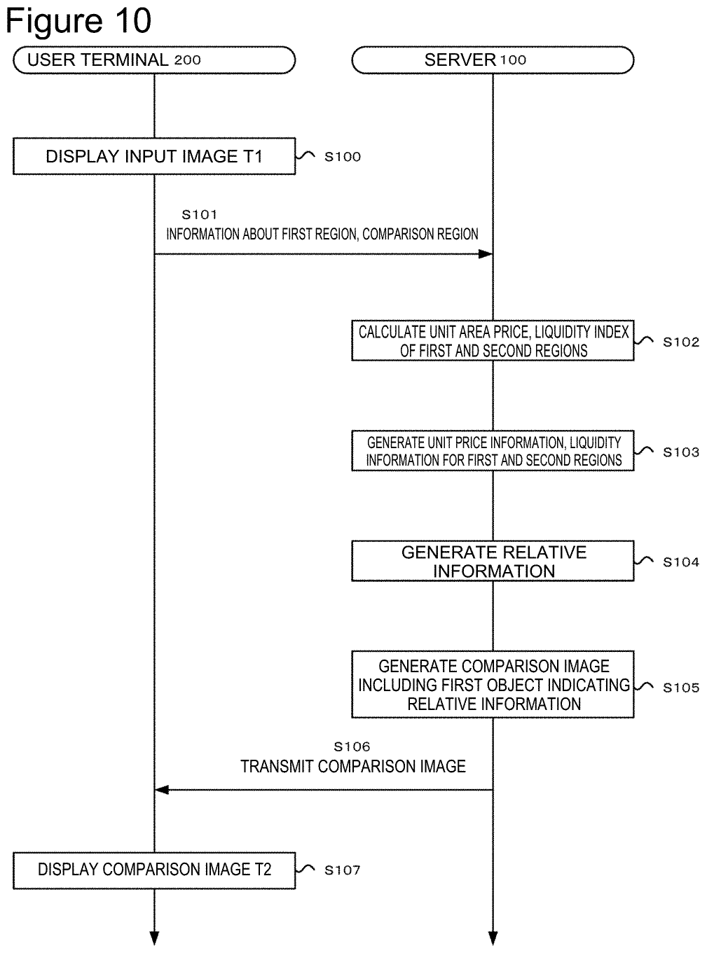

Next, a procedure of information processing according to the first embodiment will be described by referring to FIG. 10 as appropriate. FIG. 10 is a flowchart showing a procedure of information processing by the property system 10 according to the first embodiment. In FIG. 10, information obtained under conditions that the comparison region is a range within a “1-km radius” of the first region included in “Roppongi, 1-chome” is provided to the user, for example.

First, in step S100, the user terminal 200 causes the display unit 205a to display the input image T1 transmitted from the server 100. In the case where input of an operation by the user is made to the setting section T11, the region setting section T11 and the setting confirmation section T13 in the input image T1, the user terminal 200 transmits information about the first region and information about the comparison region to the server 100 via the communication I/F 24.

Next, in step S101, the server 100 receives the information about the first region and the information about the comparison region from the user terminal 200 via the communication I/F 103.

Next, in step S102, the server 100 calculates the unit area price and the liquidity index in the first region and the second region included in the comparison region, by referring to the property index information D111, for example.

Next, in step S103, the server 100 generates the first unit price information and the first liquidity information for the first region, and generates the second unit price information and the second liquidity information for each second region included in the comparison region, for example.

Next, in step S104, the server 100 generates the relative information for each second region, for example. In step S105, the server 100 applies, to each second region, the first object that is color-coded based on the relative information, and generates the comparison image T2 for the comparison region, for example. In step S106, the server 100 transmits the comparison image T2 to the user terminal 200.

Next, in step S107, the user terminal 200 causes the display unit 205a to display the comparison image T2. The user may thereby grasp the unit area price and the liquidity index in the second region relative to the first region.

When the liquidity index is grasped in the above manner, a real-estate agency in purchase and resale business, for example, may easily grasp whether a real estate in an area that is highly rated with respect to liquidity of property is being chosen, and such a liquidity index may be used as important information for evaluating property.

### First Modification of First Embodiment

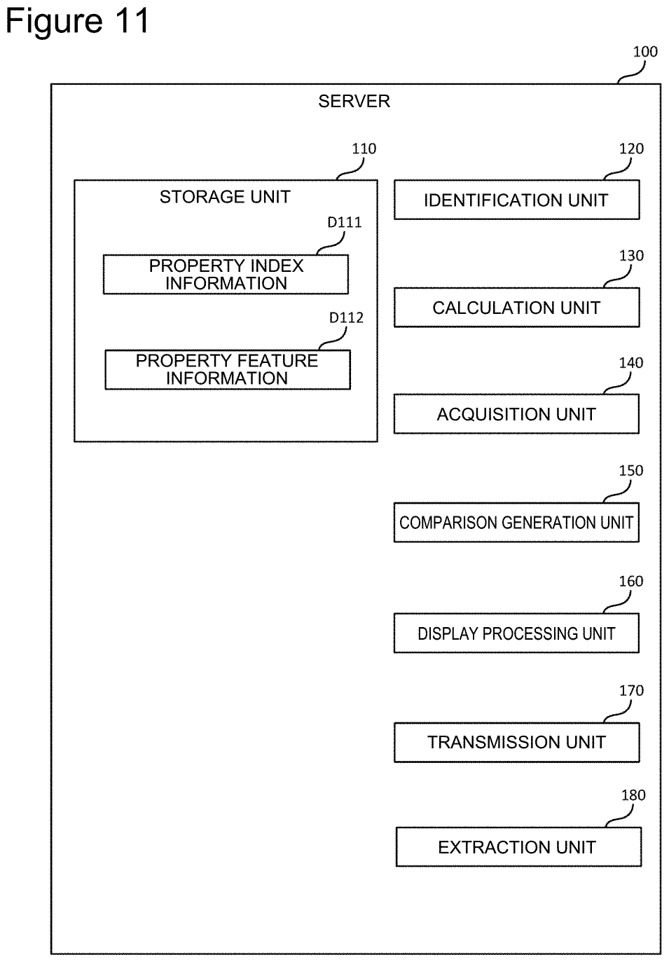

A first modification of the first embodiment will be described with reference to FIG. 11. FIG. 11 is a diagram showing the configuration of the server 100 according to the first modification of the first embodiment.

The server 100 according to the first modification of the first embodiment narrows down properties based on features of properties, and calculates the relative information using the unit price information and the liquidity information for the narrowed-down properties. Furthermore, the server 100 may include a function of calculating the relative information on a per time basis, and of displaying the relative information reflecting continuous (intermittent) temporal changes. When compared with the first embodiment, the server 100 of the first modification further includes an extraction unit 180, for example.

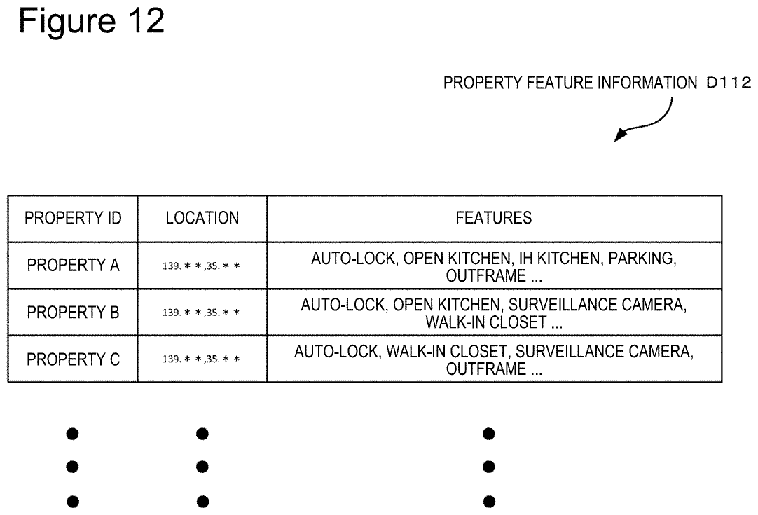

The server 100 further stores the property feature information D112 in the storage unit 110, for example. FIG. 12 is a diagram showing an example of the property feature information D112. As shown in FIG. 4, the property feature information D112 includes the following items, for example: property ID, location, and features.

The items “property ID” and “location” are the same as “property ID” and “location” in the property index information D111, and description thereof is omitted.

“Features” is an item that is associated with “property ID”, and that indicates a feature of a property, for example. The features of a property may include features related to facility of the property and features related to a surrounding environment of the property, for example. Specifically, the features of a property indicate whether “separate bath/toilet”, “walk-in closet”, “IH cooking heater”, “parking”, “auto-lock”, “surveillance camera” and the like are satisfied, or whether locational requirements such as “close to park”, “close to shopping center”, “close to station” and the like are satisfied, for example.

The identification unit 120 identifies the features of a property specified by the user, for example.

The server 100 further includes the extraction unit 180, for example. The extraction unit 180 extracts a property (property ID) including the features identified by the identification unit 120, among the properties in the comparison region.

The acquisition unit 140 refers to the property index information D111, and acquires the first unit price information and the first liquidity information, and the second unit price information and the second liquidity information of the property that is extracted by the extraction unit 180, for example. Alternatively, the acquisition unit 140 may refer to the property index information D111, and acquire the first unit price information and the first liquidity information and the second unit price information, and the second unit price information and the second liquidity information of a property, that are extracted by the extraction unit 180.

The comparison generation unit 150 generates the relative information between the first unit price information and the first liquidity information, and the second unit price information and the second liquidity information of a property extracted by the extraction unit 180, for example. Alternatively, the comparison generation unit 150 may generate the relative information between the first unit price information and the first liquidity information, and the second unit price information and the second liquidity information, of properties extracted by the extraction unit 180, for example. In the following, a description will be given assuming that the comparison generation unit 150 generates the relative information between the first unit price information and the first liquidity information, and the second unit price information and the second liquidity information of a property that is extracted by the extraction unit 180.

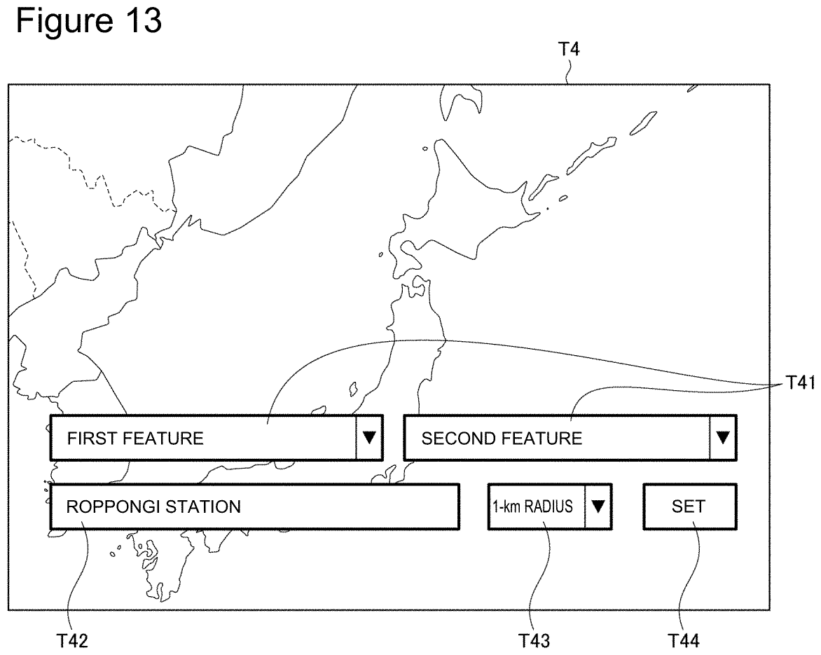

The display processing unit 160 generates an input image T4 and a feature comparison screen T4, for example. FIG. 13 is a diagram showing an example of the input image T4. As shown in FIG. 13, the input image T4 includes at least feature setting sections T41, a first region setting section T42, a comparison region setting section T43, and a setting confirmation section T44, for example. The first region setting section T42, the comparison region setting section T43, and the setting confirmation section T44 are the same as the setting section T11, the region setting section T11, and the setting confirmation section T13 shown in FIG. 5, and description thereof will be omitted. The feature setting sections T41 are objects used to set features of a property, and may be configured such that a feature is specified by a pull-down menu, for example. The identification unit 120 identifies the feature that is set in the feature setting section T41, for example. Additionally, the feature setting sections T41 may be configured to allow a plurality of features to be set, for example.

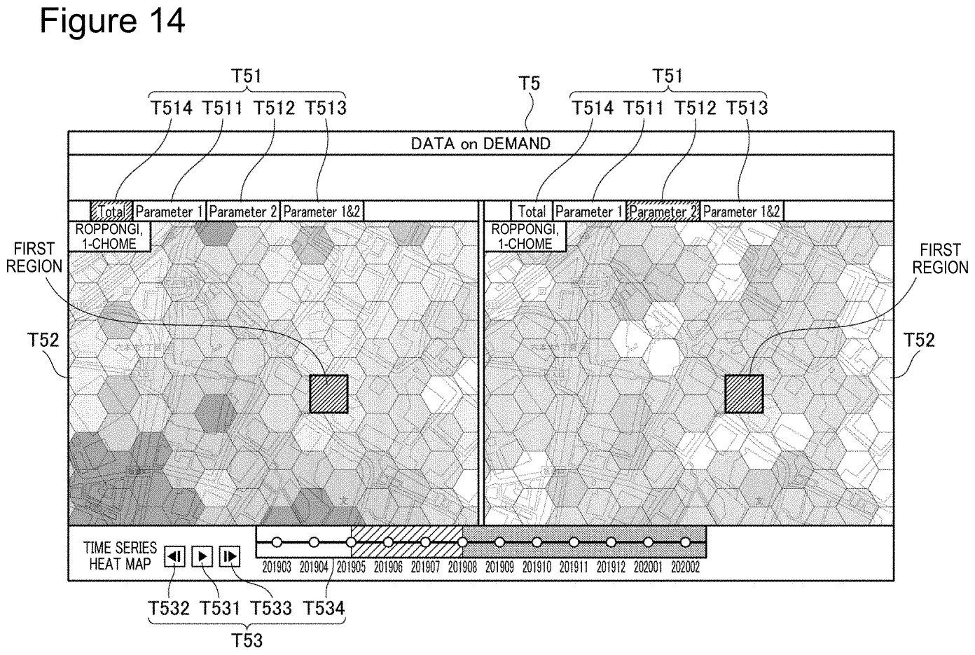

FIG. 14 is a diagram showing an example of the feature comparison image T5. As shown in FIG. 14, the feature comparison image T5 includes feature switching sections T51, comparison display sections T52, and a time-series display section T53. The feature switching section T51 is a button for causing the extraction unit 180 to extract a property including the feature set in the feature switching section T51, in a case where input thereto of an operation is made on the user terminal 200 by the user, for example. The feature switching section T51 includes a first feature setting section T511 for setting a first feature, a second feature setting section T512 for setting a second feature, an overall feature setting section T513 for setting the first and second features, and an exclusion setting section T514 for generating the relative information without setting features. The first feature setting section T511, the second feature setting section T512, and the overall feature setting section T513 are each a button for causing the extraction unit 180 to extract a property including the corresponding feature(s) in the case where input thereto of an operation is made on the user terminal 200 by the user, for example. The exclusion setting section T514 is a button for preventing a property from being extracted while being limited based on features, in the case where input thereto of an operation is made on the user terminal 200 by the user, for example. The user may thereby grasp the degree of influence of a feature of a property on the unit area price and the liquidity.

The comparison display section T52 is a display region for displaying the relative information about a property extracted by the extraction unit 180, for example. The user is thereby enabled to grasp, using the user terminal 200, the unit area price and the liquidity of a property having specific features, in a specific region. Accordingly, the user may make an investment in a property having features that may produce a higher yield.

The time-series display section T53 includes a play button T531, a rewind button T532, a fast forward button T533, and a time meter T534, for example. The time-series display section T53 is a region for displaying the time corresponding to the relative information that is displayed in the comparison display section T52, for example. The play button T531 is a button for causing the time to advance and for causing the display processing unit 160 to cause the relative information corresponding to the time to be displayed in the comparison display section T52, in the case where input thereto of an operation is made on the user terminal 200 by the user, for example. The rewind button T532 is a button for rewinding the time and for causing the display processing unit 160 to cause the relative information corresponding to the time to be displayed in the comparison display section T52, in the case where input thereto of an operation is made on the user terminal 200 by the user, for example. The fast forward button T533 is a button for fast forwarding the time and for causing the display processing unit 160 to cause the relative information corresponding to the time to be displayed in the comparison display section T52, in the case where input thereto of an operation is made on the user terminal 200 by the user, for example. The time meter T534 is an object for displaying the time corresponding to the relative information that is displayed in the comparison display section T52, for example. The user is thereby enabled to easily grasp the manner of change in the unit area price and the liquidity from the past to the present using the user terminal 200, and to make an appropriate investment in property.

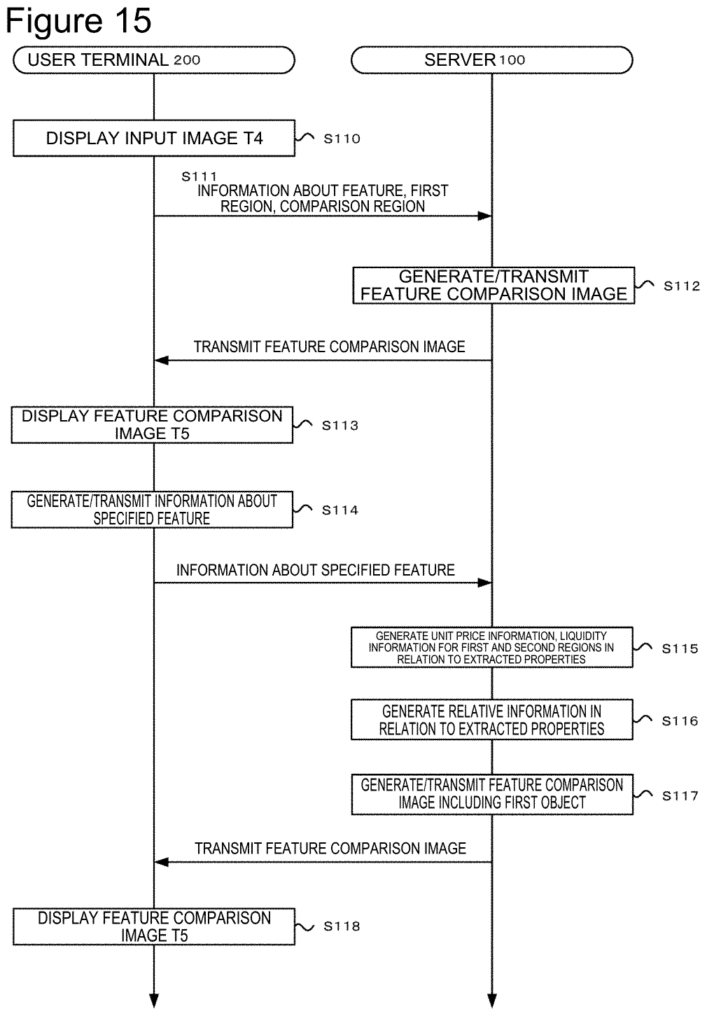

Next, a procedure of information processing according to the first modification of the first embodiment will be described by referring to FIG. 15 as appropriate. FIG. 15 is a flowchart showing a procedure of information processing by the property system 10 according to the first modification of the first embodiment. In FIG. 15, a range within a “1-km radius” of the first region included in “Roppongi, 1-chome” is taken as the comparison region, the first feature is that “auto-lock” is included, and the second feature is that “surveillance camera” is included, for example.

First, in step S110, the user terminal 200 causes the display unit 205a to display the input image T4 transmitted from the server 100. In step S111, in the case where there is input of operations by the user to the feature setting sections T41, the first region setting section T42, the comparison region setting section T43, and the setting confirmation section T44 in the input image T4, the user terminal 200 transmits information about the features, information about the first region, and information about the comparison region to the server 100 via the communication I/F 24.

Next, in step S112, the server 100 generates the feature comparison image T5 based on the information about the features, the information about the first region, and the information about the comparison region, for example. The server 100 transmits the feature comparison image T5 to the user terminal 200, for example.

Next, in step S113, the user terminal 200 causes the display unit 205a to display the feature comparison image T5 transmitted from the server 100. In step S114, in the case where there is input to the feature switching section T51 from the user, the user terminal 200 transmits, to the server 100, information about the feature (the first feature and/or the second feature) specified by the user (with respect to the comparison display sections T52 in FIG. 14, “first feature” is selected on the left, and “second feature” is selected on the right), for example.

Next, in step S115, the server 100 receives the information about the feature specified by the user, from the user terminal 200 via the communication I/F 103. Based on the information about the feature, the server 100 refers to the property feature information D112 and extracts a property with the first feature and/or the second feature, for example. The server 100 refers to the property index information D111, and calculates the unit area price and the liquidity index in the first region and calculates, for the extracted property, the unit area price and the liquidity index in the second region, and generates the first unit price information, the first liquidity information, the second unit price information, and the second liquidity information for example.

Next, in step S116, the server 100 generates the relative information for each second region, for example. In step S117, the server 100 generates the feature comparison image T5 (see FIG. 14) in which the color-coded first object is applied to each second region based on the relative information, for example. In step S116, the server 100 transmits the feature comparison image T5 to which the first objects are applied, to the user terminal 200.

Next, in step S118, the user terminal 200 causes the display unit 205a to display the feature comparison image T5. The user may thereby grasp the unit area price and the liquidity index of a property having a specific feature (“auto-lock” and/or “surveillance camera”) in the second region, relative to a property in the first region.

Specifically, when considering installation of a smart key, upgrading to all-electric, or refurbishing of a wooden floor, the user narrows down the properties based on such features, for example. The user may thereby grasp how much a rent unit price or a sale unit price may be increased or how swiftly a deal can be agreed regarding sale or rental thanks to such changes. Accordingly, the user may narrow down and grasp important footholds at the time of exploiting a new business opportunity to increase sales with limited staff.

### Second Modification of First Embodiment

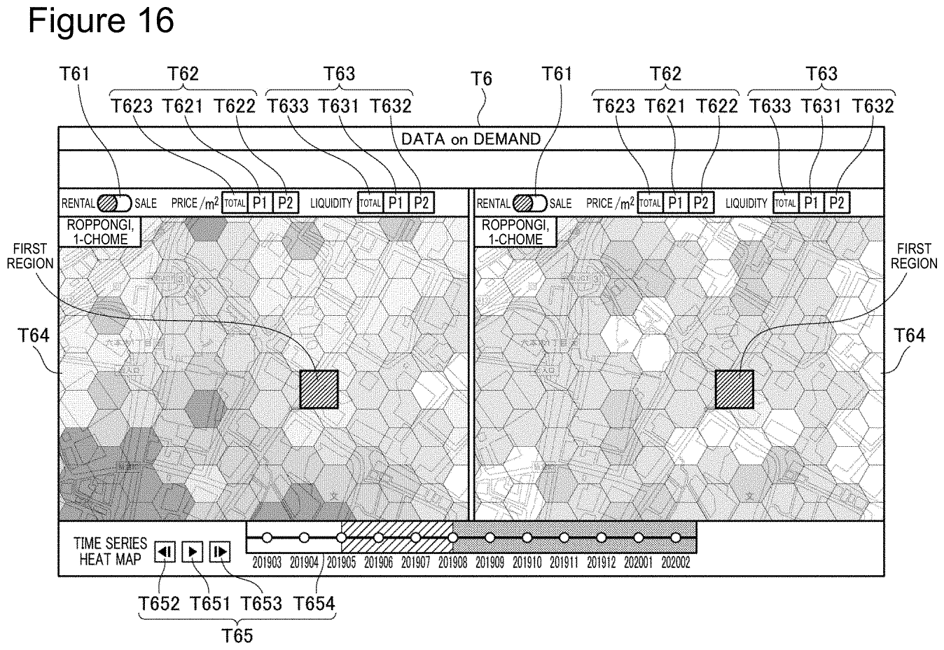

A second modification of the first embodiment will be described with reference to FIG. 16. FIG. 16 is a diagram showing a feature comparison image T6 that is generated by the server 100 according to the second modification of the first embodiment.

The server 100 according to the second modification of the first embodiment is capable of narrowing down and extracting properties based on features of the properties, in relation to each of the unit area price and the liquidity index.

As shown in FIG. 16, the display processing unit 160 generates the feature comparison image T6 including a rent/sale switching section T61, a unit price feature switching section T62, and a liquidity feature switching section T63, for example. The rent/sale switching section T61 is a button used to switch a research mode according to a selected mode, for example. Specifically, the rent/sale switching section T61 may be a button for switching between a mode for doing research on the unit area price and the liquidity in relation to sale/purchase of a property, and a mode for doing research on the unit area price and the liquidity in relation to rental of a property.

The unit price feature switching section T62 includes a first unit price feature setting section T621 for setting a first feature, a second unit price feature setting section T622 for setting a second feature, and an exclusion setting section T623 for generating the relative information without setting features, for example. The first unit price feature setting section T621 and the second unit price feature setting section T622 are each a button for causing the extraction unit 180 to extract a property including the corresponding feature in the case where input thereto of an operation is made on the user terminal 200 by the user, for example. The exclusion setting section T623 is a button for preventing a property from being extracted while being limited based on features, in the case where input thereto of an operation is made on the user terminal 200 by the user, for example. The user may thereby grasp the degree of influence of a feature that is set, on the unit area price.

The liquidity feature switching section T63 includes a first liquidity feature setting section T631 for setting a first feature, a second liquidity feature setting section T632 for setting a second feature, and an exclusion setting section T633 for generating the relative information without setting features, for example. Operations that are performed in the case where there is input of operations to the first liquidity feature setting section T631, the second liquidity feature setting section T632 and the exclusion setting section T633 on the user terminal 200 by the user are the same as in the case of the first unit price feature setting section T621, the second unit price feature setting section T622, and the exclusion setting section T623, and description thereof will be omitted. The user may thereby grasp the degree of influence of a feature that is set, on the liquidity.

### Second Embodiment

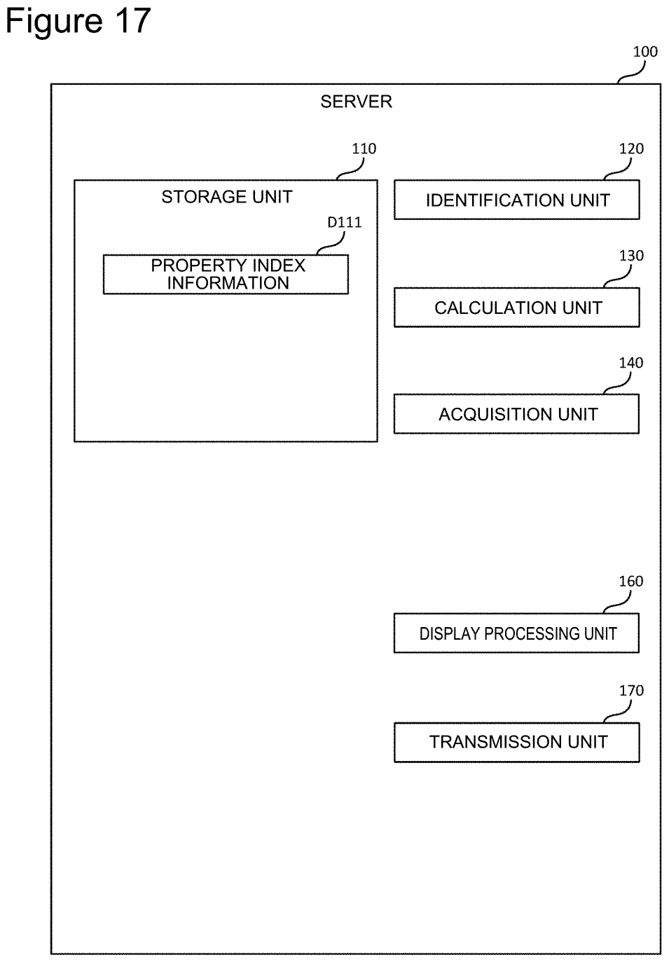

The property system 10 according to a second embodiment will be described with reference to FIG. 17. FIG. 17 is a diagram showing an example of a functional configuration of the server 100 according to the second embodiment. The present embodiment is a mode in which an image including a graph associating a plurality of time points with the unit price information and the liquidity information for a predetermined region is generated by the server 100, for example. The user may thereby easily grasp how the unit area price and the liquidity are changed over time, by using the user terminal 200.

The server 100 includes the storage unit 110, the identification unit 120, the calculation unit 130, the acquisition unit 140, the display processing unit 160, and the transmission unit 170, for example. In the following, description of components the same as those of the property system 10 according to the first embodiment will be omitted as appropriate.

The storage unit 110 includes the property index information D111, for example. The property index information D111 is as described above, and description thereof will be omitted.

The identification unit 120 identifies a region that is specified by input of an operation on the user terminal 200 by the user (hereinafter “specified region”), for example. Additionally, the specified region may be specified using a lot number or may be specified using the name of a property. Furthermore, the specified region may be a region within a predetermined radius of a location that is specified by input by the user, for example.

The calculation unit 130 calculates the unit area price and the liquidity index in the specified region identified by the identification unit 120, for example.

The acquisition unit 140 acquires, from the storage unit 110, various pieces of information such as the unit price information and the liquidity information for the predetermined region, for example.

The display processing unit 160 generates various images, for example. The display processing unit 160 generates an object that indicates a relation between the unit price information and the liquidity information, and whose color is changed according to the time (hereinafter “second object”), for example. The second objects may be formed such that the color becomes darker from an earliest time point to a latest time point in a time period specified by the user, for example. Furthermore, the second objects may be formed such that the color is changed in stages (from red to blue, for example) from the earliest time point to the latest time point, for example. The display processing unit 160 plots the second object on the graph based on the unit area price indicated by the unit price information and the liquidity index indicated by the liquidity information, that are associated with the second object, and thus generates a transition image T8 described later.

Next, various images that are generated by the display processing unit 160 will be described. The display processing unit 160 generates an input image T7 used by the user to input various pieces of information, and the transition image T8 showing the graph including the second objects, for example.

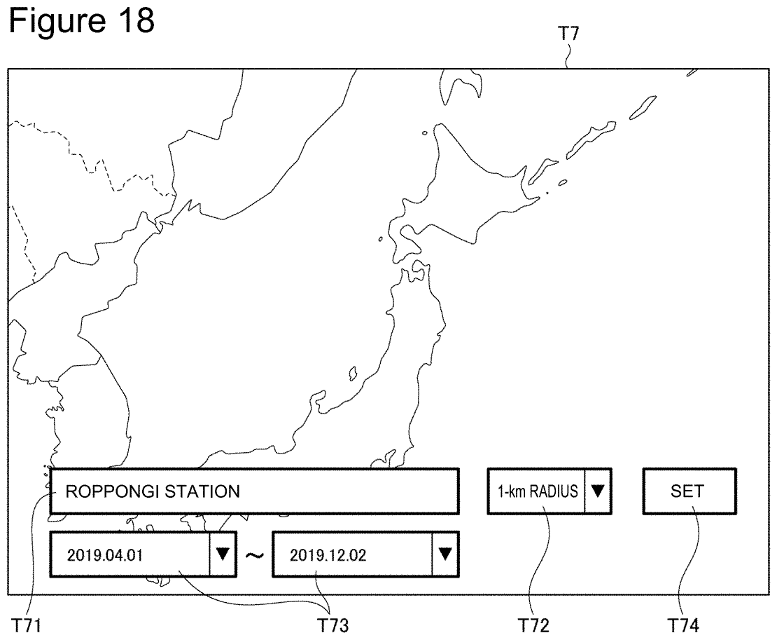

FIG. 18 is a diagram showing an example of the input image T7. As shown in FIG. 18, the input image T7 includes at least a setting section T71, a region setting section T72, time period setting sections T73, and a setting confirmation section T74, for example. The setting section T71 is an object for specifying a center point of the specified region, and may be a text box, for example. The region setting section T72 is a part used to specify a distance from the center point and to specify a range of the specified region, and may be configured such that the specified region is specified by a pull-down menu, for example. The time period setting sections T73 are parts used to specify the period of time for extracting information, and may be configured such that the time period is set by a pull-down menu, for example. The setting confirmation section T74 is the same as the setting confirmation section T13, and description thereof is omitted.

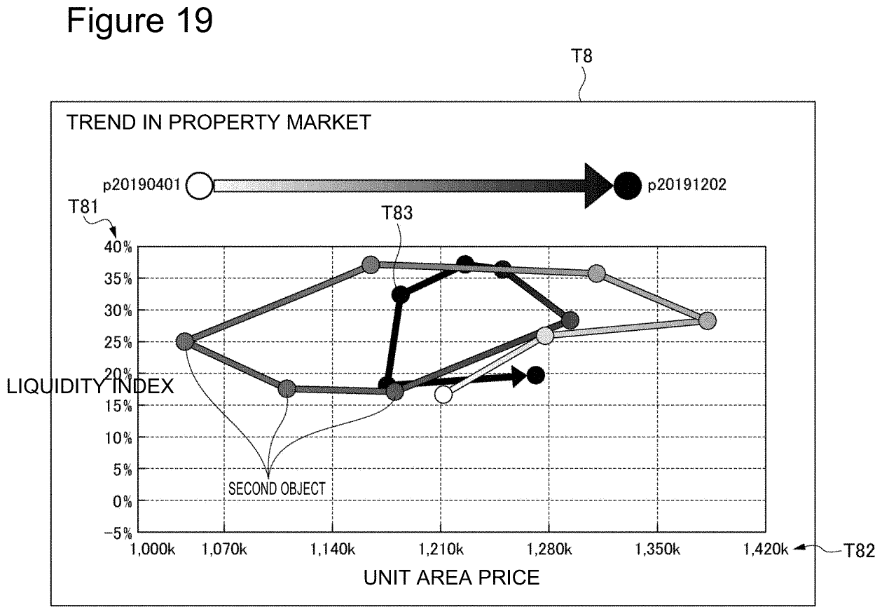

FIG. 19 is a diagram showing an example of the transition image T8. As shown in FIG. 19, the transition image T8 includes a horizontal axis T82 indicating the unit area price and a vertical axis T81 indicating the liquidity index, and the second objects corresponding to the indices are plotted, for example. Specifically, the second object with a lightest color indicates the unit area price and the liquidity index at the earliest time point, and the second object with a darkest color indicates the unit area price and the liquidity index at the latest time point. The user may thus easily visually grasp how the unit area price and the liquidity are changed over time, by using the user terminal 200. Moreover, when the liquidity index is associated with the unit area price, the user may grasp that there are many properties that are highly priced but have low liquidity, from the transition image T8. Furthermore, the display processing unit 160 may generate the transition image T8 by connecting two second objects that are temporally adjacent to each other with a line-shaped object, for example. The user may thereby more easily grasp the change in the unit area price and the liquidity index over time.

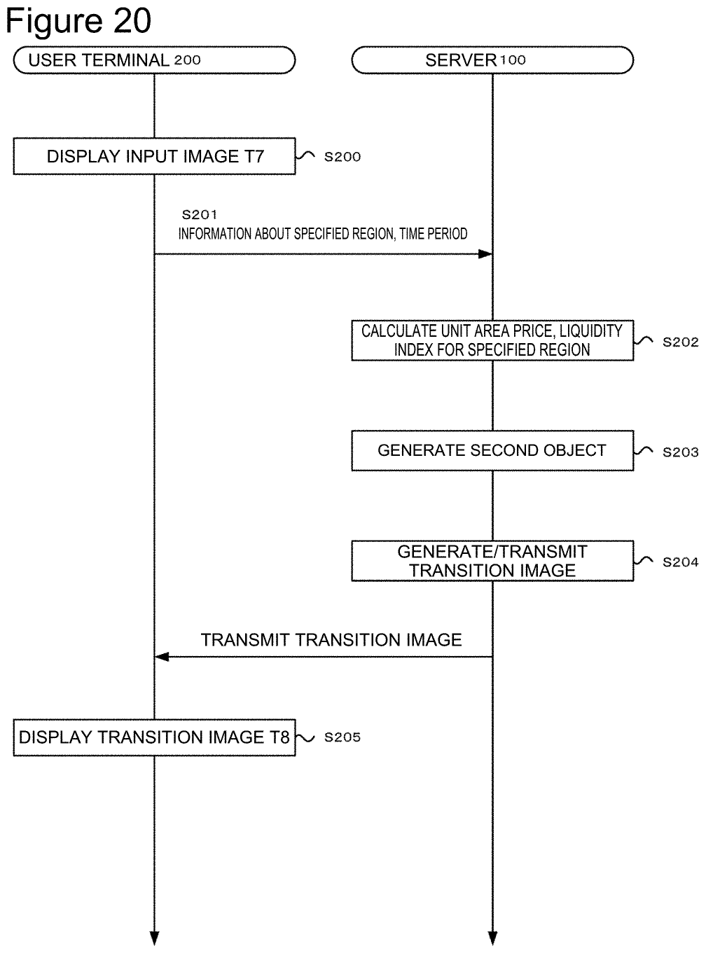

Next, a procedure of information processing according to the second embodiment will be described by referring to FIG. 20 as appropriate. FIG. 20 is a flowchart showing a procedure of information processing by the property system 10 according to the second embodiment. In FIG. 20, information obtained under conditions that the specified region is a range within a “1-km radius” of “Roppongi, 1-chome” is provided to the user, for example.

First, in step S200, the user terminal 200 causes the display unit 205a to display the input image T7 transmitted from the server 100. In the case where input of an operation by the user is made to the setting section T71, the region setting section T72, the time period setting sections T73, and the setting confirmation section T74 in the input image T7, the user terminal 200 transmits information about the specified region and information about the time period to the server 100 via the communication I/F 24.

Next, in step S201, the server 100 receives the information about the specified region and the information about the time period from the user terminal 200 via the communication I/F 103.

Next, in step S202, the server 100 calculates the unit area price and the liquidity index for the specified region in the time period specified by the user, based on the information about the specified region and the information about the time period and by referring to the property index information D111, for example.

Next, in step S203, the server 100 generates the second objects whose colors are changed according to time, for example. In step S204, the server 100 plots the second objects on the graph and generates the transition image T8, for example. The server 100 transmits the transition image T8 to the user terminal 200.

Next, in step S205, the user terminal 200 causes the display unit 205a to display the transition image T8. The user may thereby grasp changes over time in the unit area price and the liquidity index of a property in the specified region.

### Modification of Second Embodiment

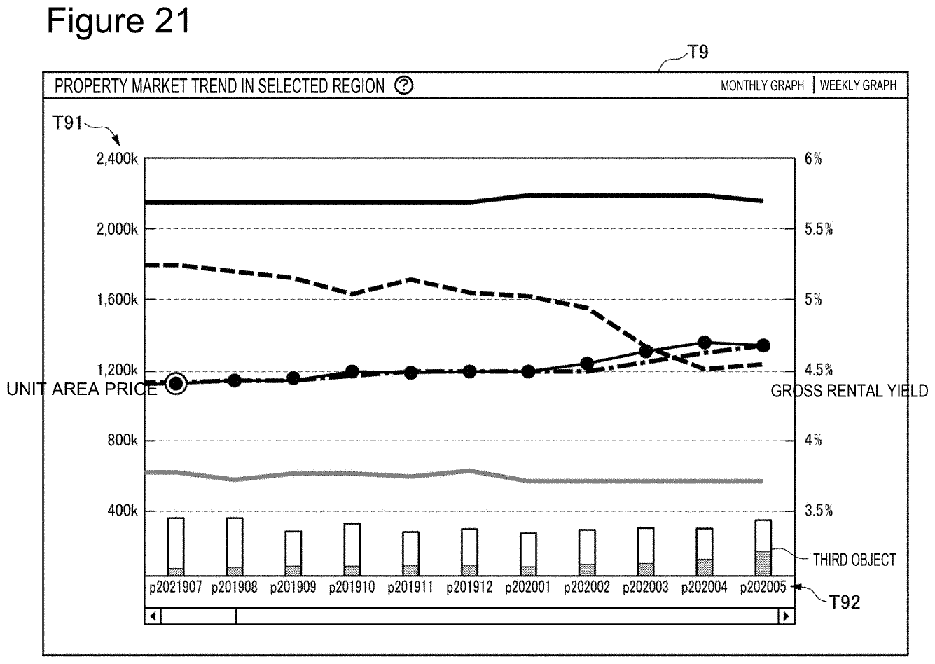

The property system 10 according to a modification of the second embodiment will be described with reference to FIG. 21. FIG. 21 is a diagram showing an example of a transition image T9. The present modification is a mode in which the server 100 associates a plurality of time points with the unit price information for a predetermined region and performs plotting on a graph, for example. Furthermore, in the present modification, the liquidity index (hereinafter sometimes referred to as “degree of liquidity”) is displayed in a visually easily understandable manner, in association with the plurality of time points, for example.

The display processing unit 160 generates the transition image T9 shown in FIG. 21. As shown in FIG. 21, in the transition image T9, a graph having a horizontal axis T92 indicating a time and a vertical axis T91 indicating the unit area price, and objects indicating the degree of liquidity (hereinafter “third objects”) are displayed, for example. The display processing unit 160 plots the unit area price calculated by the calculation unit 130 on the graph, in association with the time, for example. The user may thereby easily grasp time-series transition of the unit area price.

The display processing unit 160 generates the third objects in association with the time points. The third object is an object that indicates the liquidity information by displaying the degree of liquidity of a property in the specified region using a size of an area shown in a color, for example. Specifically, the third object has a predetermined shape (such as a rectangle), and a region, of the predetermined shape, corresponding to the proportion of properties that were traded to all the properties in the specified region is displayed in a first color, for example. Furthermore, with the third object, a region, of the predetermined shape, corresponding to the proportion of properties that were not traded to all the properties in the specified region is displayed in a second color. The display processing unit 160 arranges the third objects corresponding to respective time points, on the horizontal axis, for example. The user may thereby easily visually grasp the liquidity index of property. Furthermore, the user may easily grasp the liquidity index of property together with transition of the unit area price, and may thus make an appropriate investment in property.

Additionally, with respect to the graph in the transition image T9, the display processing unit 160 may set a value of property different from the unit area price, on a vertical axis opposite the vertical axis indicating the unit area price. For example, an index related to a gross rental yield of property may be set. The user may thus obtain a greater amount of information about time-based transition related to property, and may make an appropriate investment in property.

### Third Embodiment

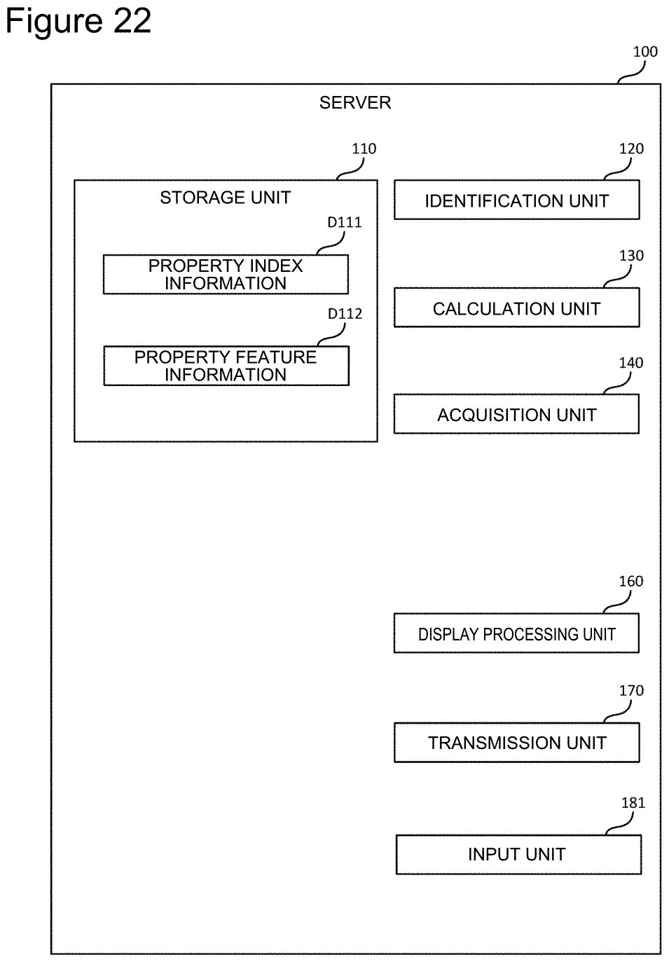

The property system 10 according to a third embodiment will be described with reference to FIG. 22. FIG. 22 is a diagram showing an example of a functional configuration of the server 100 according to the third embodiment. The present embodiment is a mode in which the server 100 identifies a feature of a property that affects the price of the property in a predetermined region, for example. The user may thereby easily grasp, by using the user terminal 200, what feature should be added to a property or what feature should be included when choosing a property in which to invest, at the time of making an investment in property in a specific region. As described above, the feature included in a property (hereinafter sometimes referred to as “feature of a property”) may include a feature related to facility of the property or a feature related to a surrounding environment of the property, for example.

The server 100 includes the storage unit 110, the identification unit 120, the calculation unit 130, the acquisition unit 140, the display processing unit 160, the transmission unit 170, and an input unit 181, for example. In the following, description of components the same as those of the property system 10 according to the first embodiment will be omitted as appropriate.

The storage unit 110 includes the property index information D111 and the property feature information D112, for example. The property index information D111 and the property feature information D112 are as described above, and description thereof is omitted.

The identification unit 120 identifies information about a purpose of a property (hereinafter “purpose information”) that is specified by input of an operation on the user terminal 200 by the user, for example. The purpose of a property is rental, sale/purchase or the like of the property, for example. Furthermore, the identification unit 120 identifies a region that is specified by input of an operation on the user terminal 200 by the user (hereinafter “specified region”), for example. The specified region may be specified using a lot number or may be specified using the name of a property. Furthermore, the specified region may be a region within a predetermined radius of a location that is specified by input by the user, for example.

The input unit 181 inputs information about the specified region and the purpose information to a learned model, for example. The learned model here includes a neural network, for example. The learned model is a model that is learned by taking, as input data, information indicating the feature of a property in a predetermined region and the unit price information and the liquidity information of the corresponding property, for example. When information about the specified region (including information indicating the location of a property) and the purpose information are input, the learned model outputs the feature of a property that affects the price of the property in the specified region. More specifically, the learned model outputs a feature that most affects the price of a property (hereinafter “first feature”), for example. Then, the learned model may output, in relation to the property including the first feature, the feature of a property that most affects the price of the property (hereinafter “second feature”), for example. Furthermore, the learned model may output, in relation to a property not including the first feature, the feature of a property that most affects the price of the property (hereinafter “third feature”), for example.

Additionally, the property system 10 may, but not necessarily, include the learned model. In the case where the property system 10 does not include the learned model, the property system 10 may transmit information about the specified region and the purpose information to another apparatus including the learned model, and may receive the result, for example.

The acquisition unit 140 acquires, from the learned model, information about the features (the first to third features) regarding a property that affect the price of the property, in relation to the specified region and the purpose of a property, for example.

The display processing unit 160 generates an input image T10 used by the user to input various pieces of information, and a feature-related image T11 showing a decision tree associating features of a property, for example.

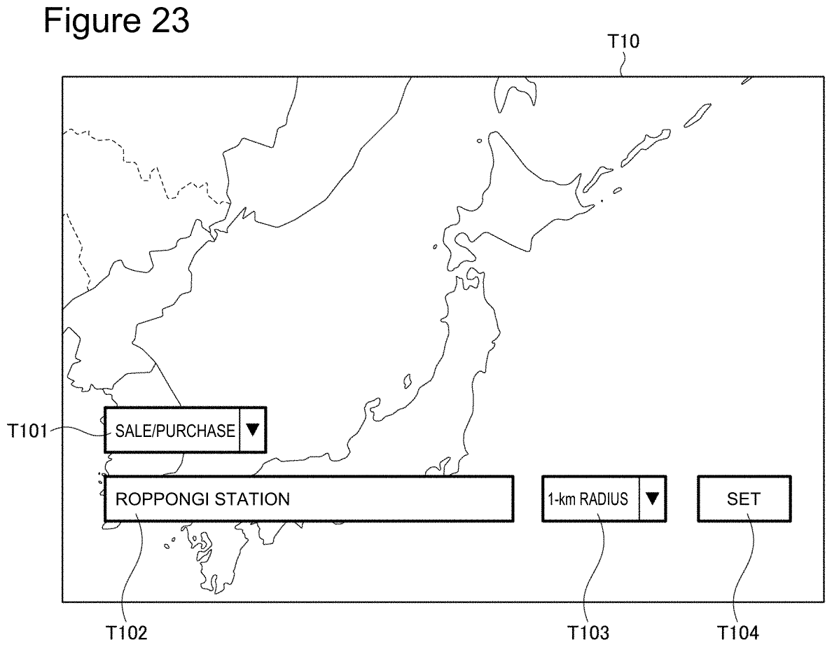

FIG. 23 is a diagram showing an example of the input image T10. As shown in FIG. 23, the input image T10 includes at least a purpose setting section T101, a location setting section T102, a region setting section T103, and a setting confirmation section T104, for example. The input image T10 may further include a year built setting section for allowing setting of a year built, and a room layout setting section for allowing setting of a room layout, for example. Additionally, the location setting section T102, the region setting section T103, and the setting confirmation section T104 are the same as the setting section T71, the region setting section T72, and the setting confirmation section T74, and description thereof will be omitted. The purpose setting section T101 is configured such that sale/purchase or rental is selected by a pull-down menu when input thereto of an operation is received on the user terminal 200 from the user, for example.

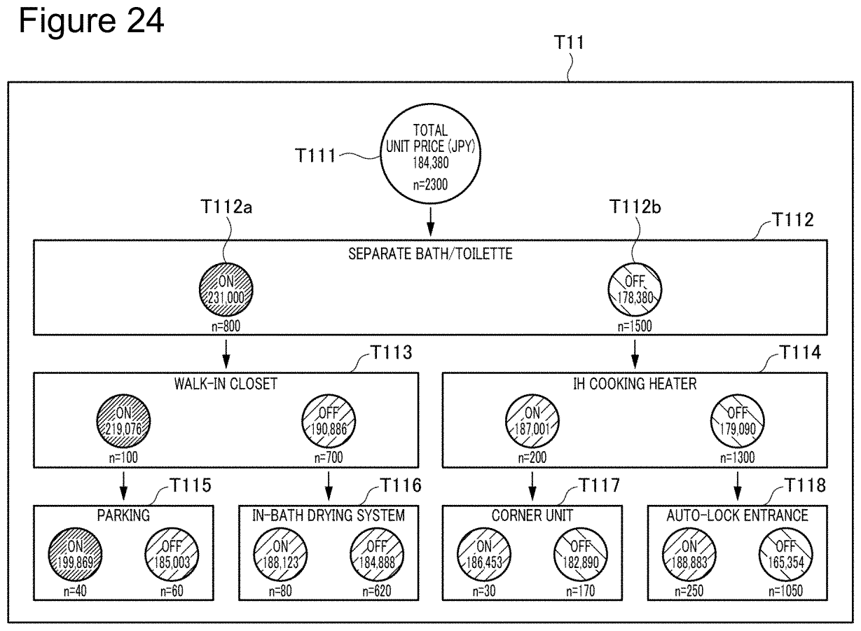

FIG. 24 is a diagram showing an example of the feature-related image T11. As shown in FIG. 24, the feature-related image T11 includes a total object T111, a first feature object T112, a second feature object T113, and a third feature object T114, for example. The total object T111 is an object indicating the number of properties (in this case, “2,300” properties) analyzed in relation to the specified region and the purpose of property and an average value of the properties (in this case, “184,380” JPY), for example.

The first feature object T112 is an object indicating the first feature (in this case, “SEPARATE BATH/TOILETTE”) that most affects the price (in this case, a sale/purchase price) of a property that is an analysis target, for example. The user may thereby easily grasp the first feature. Furthermore, the first feature object T112 includes a first feature condition object T112a indicating the price of a property (in this case, “231,000” JPY) in the case where the first feature is included (in this case, “ON”), for example. The first feature object T112 also includes a first feature condition object T112b indicating the price of a property (in this case, “178,380” JPY) in the case where the first feature is not included or the first feature is not matched (in this case, “OFF”), for example. Additionally, the “case where the first feature is not matched” includes a case where a property possibly includes the first feature but no emphasis is placed thereon, for example. In the following, “the first feature is not included” will be described to indicate that “the first feature is not included or the first feature is not matched”. The user may thereby easily grasp how different the prices are between the case where the first feature is included and the case where the first feature is not included. Furthermore, in relation to the first feature condition object T112a and the first feature condition object T112b, the first feature object T112 may show the one with a higher price of property in a first color (in this case, red), and the one with a lower price of property in a second color (in this case, blue). The user may thereby easily visually grasp what feature increases the price.

The second feature object T113 is an object indicating the second feature of a property (in this case, “WALK-IN CLOSET”) that most affects the price of the property, in relation to properties including the first feature, for example. The user may thereby easily grasp the second feature. Objects forming the second feature object T113 are the same as the objects forming the first feature object T112, and description thereof is omitted. The third feature object T114 is an object indicating the third feature of a property (in this case, “IH COOKING HEATER”) that most affects the price of the property, in relation to properties not including the first feature, for example. The user may thereby easily grasp the second feature. Objects forming the second feature object T113 are the same as the objects forming the first feature object T112, and description thereof is omitted.

Additionally, relations between the first feature, the second feature, and the third feature are described above for the sake of convenience, but the display processing unit 160 may further display a feature that most affects the price of a property in the case where the second feature is included or is not included (in this case, an object T115, an object T116), and a feature that most affects the price of a property in the case where the third feature is included or is not included (in this case, an object T117, an object T118), for example, and a display range of analysis results is not limited.

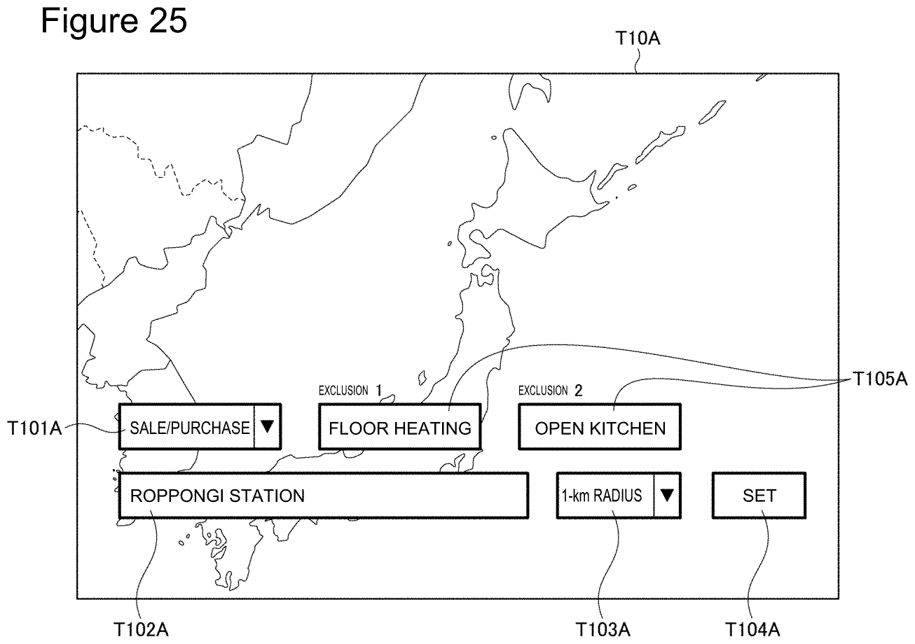

As shown in FIG. 25, the input image T10 may further includes feature exclusion sections T105A, for example. The feature exclusion section T105A is an input part for excluding a feature that is set therein from the features of a property that are output from the learned model, for example. The feature exclusion section T105A may be configured such that a feature to be excluded is specified by a pull-down menu, or may be a text box used to specify the feature to be excluded, for example, and how input is made is not particularly limited. The server 100 generates the feature-related image T11 while excluding the feature set in the feature exclusion section T105A from the features of a property that are output from the learned model, for example. Furthermore, the server 100 may input information about the specified region, the purpose information, and information about the feature set in the feature exclusion section T105A to the learned model, and may generate the feature-related image T11 based on the result, output from the learned model, obtained by excluding the feature, for example. The user may thereby grasp, by excluding the features (such as floor heating and open kitchen) that are already included in the property owned by the user, the features that are different from the above-mentioned features and that affect the price of a property, for example.

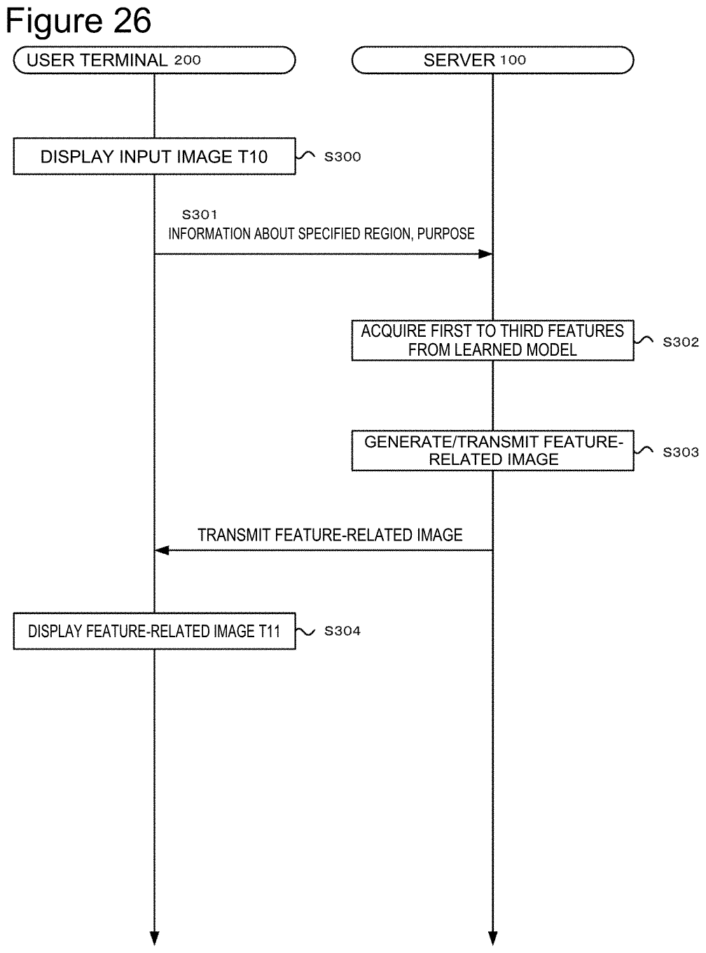

Next, a procedure of information processing according to the third embodiment will be described by referring to FIG. 26 as appropriate. FIG. 26 is a flowchart showing a procedure of information processing by the property system 10 according to the third embodiment. In FIG. 26, information obtained under conditions that the purpose of property is “sale/purchase” and the specified region is a range of a “2-km radius” of “Roppongi Station” is provided to the user, for example.

First, in step S300, the user terminal 200 causes the display unit 205a to display the input image T10 transmitted from the server 100. In step S301, in the case where input of an operation by the user is made to the purpose setting section T101, the location setting section T102, the region setting section T103, a year built setting section T104, a room layout setting section T105, and the setting confirmation section T106 in the input image T10, the user terminal 200 transmits information about the specified region and the purpose information to the server 100 via the communication I/F 24.

Next, in step S302, the server 100 receives the information about the specified region and the purpose information from the user terminal 200 via the communication I/F 103. The server 100 inputs the information about the specified region and the purpose information to the learned model, for example. The server 100 acquires, from the learned model, features that affect the price of a property (the first to third features, for example).

Next, in step S303, the server 100 generates the feature-related image T11 based on the features the affect the price of a property, for example. The server 100 transmits the feature-related image T11 to the user terminal 200.

Next, in step S304, the user terminal 200 causes the display unit 205a to display the feature-related image T11. The user may thereby grasp the features that affect the price of a property in the specified region, and may also grasp how much each feature affects the price of the property. Accordingly, the user may easily determine which feature to adopt, and may make an appropriate investment in property.

### Fourth Embodiment

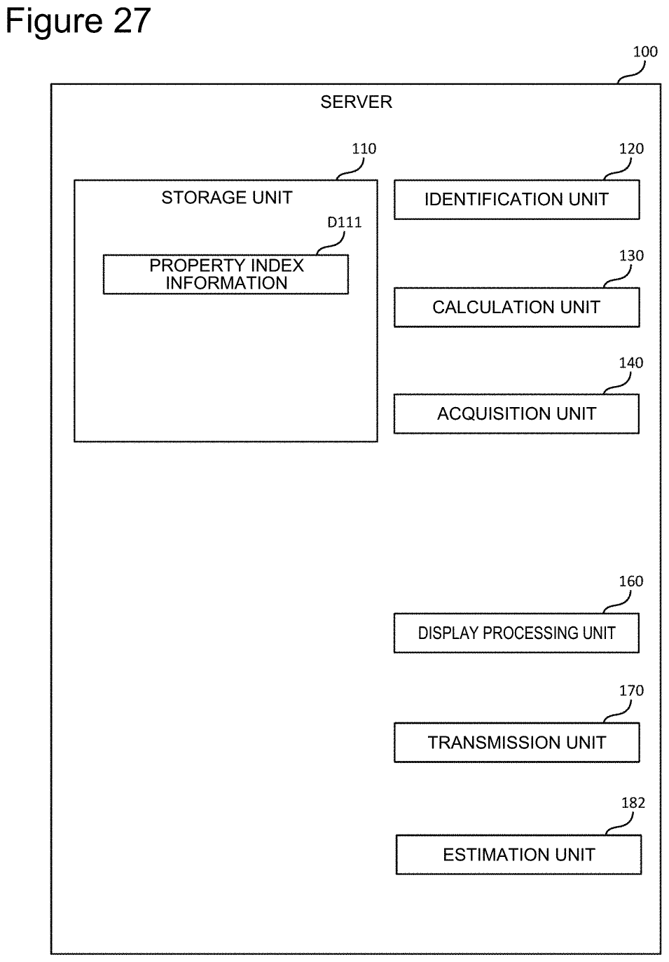

The property system 10 according to a fourth embodiment will be described with reference to FIG. 27. FIG. 27 is a diagram showing an example of a functional configuration of the server 100 according to the fourth embodiment. The present embodiment is a mode in which the server 100 calculates, for a predetermined region, an index based on the unit area price and the liquidity index, and estimates fluctuations in demand for property based on the calculated index, for example. The user may thereby estimate fluctuations in the price of property in the predetermined region by using the user terminal 200, and may make an appropriate investment in property.

The server 100 includes the storage unit 110, the identification unit 120, the calculation unit 130, the acquisition unit 140, the display processing unit 160, the transmission unit 170, and an estimation unit 182, for example. In the following, description of components the same as those of the property system 10 in the first or second embodiment will be omitted as appropriate. The storage unit 110 is the same as the storage unit 110 in the first embodiment, and description thereof is omitted.

The identification unit 120 and the acquisition unit 140 are the same as the identification unit 120 and the acquisition unit 140 in the second embodiment, and description thereof is omitted.

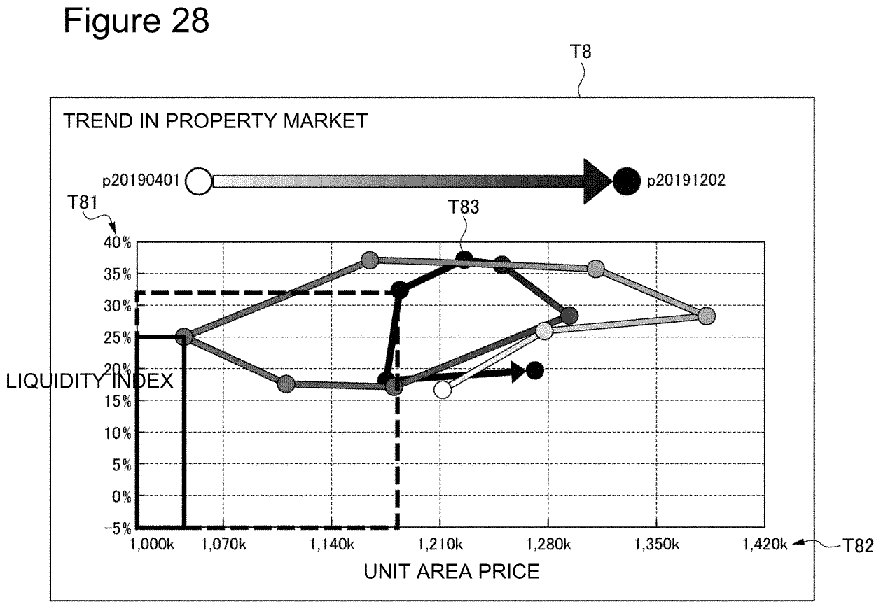

The calculation unit 130 calculates the unit area price and the liquidity index in the specified region that is identified by the identification unit 120, for example. Furthermore, the calculation unit 130 calculates a first index based on the unit price information and the liquidity information at a first time point, for example. Then, the calculation unit 130 calculates a second index based on the unit price information and the liquidity information at a second time point that is in the future relative to the first time point, for example. Specifically, the first index and the second index are each an index indicating a result of multiplying the unit area price by the liquidity index, for example. FIG. 28 is a diagram conceptually showing the first index and the second index on the transition image T8 in FIG. 19. Specifically, in the graph shown in FIG. 28, the first index is the area indicated by a solid line, and the second index is the area indicated by a dashed line, for example. The calculation unit 130 may further calculate a third index indicating a price related to a property by multiplying a calculated index (the first index, the second index) by an area size related to the property (such as a rentable area).

The estimation unit 182 estimates fluctuations in demand for property in the specified region, based on a difference between the first index and the second index, for example. Specifically, the estimation unit 182 estimates an upward trend in the demand for property in the specified region in the case where a difference obtained by subtracting the first index from the second index is positive, and estimates a downward trend in the demand for property in the specified region in the case where the difference is negative, for example.

Furthermore, the estimation unit 182 may estimate the fluctuations in demand for property in the specified region based on a difference between the third index calculated by multiplying the first index by an area size related to property, and the third index calculated by multiplying the second index by the area size related to property, for example.

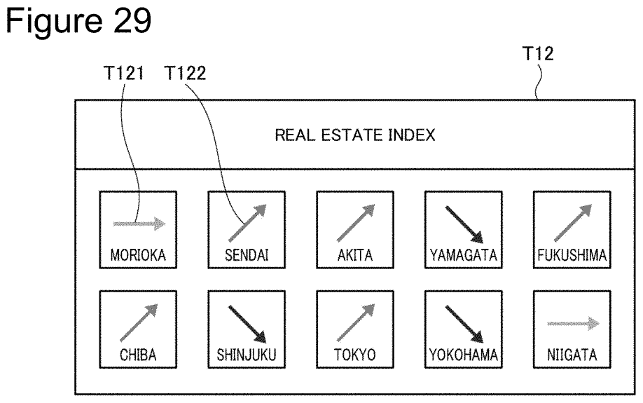

Aspects of the display processing unit 160 different from those of the display processing unit 160 according to the second embodiment will be described. FIG. 29 is a diagram showing an example of an index image T12. As shown in FIG. 29, the display processing unit 160 generates the index image T12 showing demands for property in the specified regions with arrows. Specifically, in the index image T12, the difference obtained by subtracting the first index from the second index is near zero for a specified region “MORIOKA”, and thus a horizontal arrow T121 is shown, for example. Furthermore, in the index image T12, the difference obtained by subtracting the first index from the second index is positive for a specified region “SENDAI”, and thus a right upward arrow T122 is shown, for example. The user may thereby easily grasp a trend in the demand for property in a specified region, and may make an appropriate investment in property.

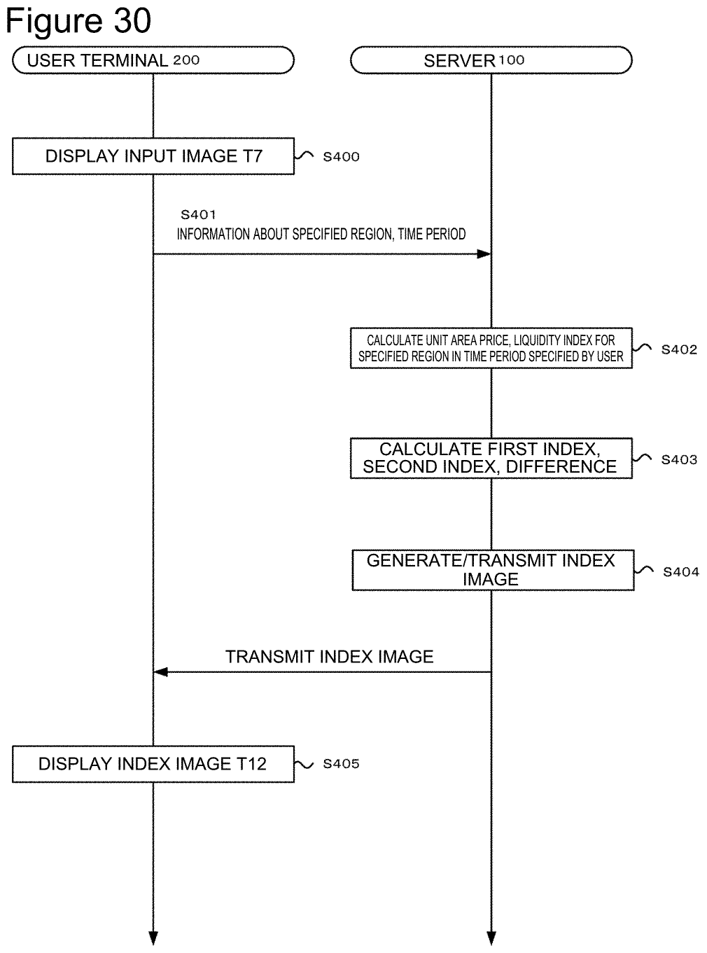

Next, a procedure of information processing according to the fourth embodiment will be described by referring to FIG. 30 as appropriate. FIG. 30 is a flowchart showing a procedure of information processing by the property system 10 according to the fourth embodiment. In FIG. 30, information obtained under conditions that the specified region is a range of a “1-km radius” of “Roppongi, 1-chome” is provided to the user, for example. Additionally, the name of a place such as “Sendai” may also be set as the specified region.

First, in step S400, the user terminal 200 causes the display unit 205a to display the input image T7 shown in FIG. 18 that is transmitted from the server 100. In step S401, in the case where input of an operation by the user is made to the setting section T71, the region setting section T72, the time period setting sections T73, and the setting confirmation section T74 in the input image T7 in FIG. 18, the user terminal 200 transmits information about the specified region and information about the time period to the server 100 via the communication I/F 24.

Next, in step S402, the server 100 receives the information about the specified region and the information about the time period from the user terminal 200 via the communication I/F 103. The server 100 calculates the unit area price and the liquidity index in the specified region in the time period specified by the user, based on the information about the specified region and the information about the time period and by referring to the property index information D111, for example.

Next, in step S403, the server 100 calculates the first index by multiplying the unit area price in the specified region at the first time point by the liquidity index, for example. Then, the server 100 calculates the second index by multiplying the unit area price in the specified region at the second time point by the liquidity index, for example. Furthermore, the server 100 calculates a difference by subtracting the first index from the second index, for example.

Next, in step S404, the server 100 generates, based on the difference, the index image T12 including an object indicating a trend in the demand for property in the specified region, for example. The server 100 transmits the index image T12 to the user terminal 200.

Next, in step S405, the user terminal 200 causes the display unit 205a to display the index image T12. The user may thereby grasp a trend in the demand for property in the specified region, and make an appropriate investment in property.

### Overview

The property system 10 includes the identification unit 120 for identifying a first region that is specified by a user, the acquisition unit 140 for acquiring first unit price information indicating a unit area price of a property in the first region, and first liquidity information indicating liquidity of the property, and the display processing unit 160 for causing the display unit 205a to display the first unit price information and the first liquidity information in association with each other. Accordingly, appropriate information about the unit area price and the liquidity of a property in a predetermined region may be provided to the user, and the user is enabled to make an appropriate investment in property.

In relation to the property system 10 according to the first embodiment, the acquisition unit 140 acquires, in relation to a second region that is specified by the user, second unit price information indicating the unit area price of a property and second liquidity information indicating the liquidity of the property, the property system 10 further includes the comparison generation unit 150 for generating relative information indicating a result of relatively comparing the first unit price information and the first liquidity information with the second unit price information and the second liquidity information, and the display processing unit 160 causes the display unit 205a to display a first object indicating the relative information. Accordingly, information about the unit area price and the liquidity in a region relative to a region as a benchmark may be provided to the user in an easily understandable manner, and the user is enabled to make an appropriate investment in property.

The display processing unit 160 of the property system 10 according to the first embodiment causes the display unit 205a to display the first object while changing a color of the first object according to divergences between the first unit price information and the first liquidity information, and the second unit price information and the second liquidity information. Accordingly, information about the unit area price and the liquidity in a region relative to a region as a benchmark may be provided to the user in a visually easily understandable manner, and the user is enabled to make an appropriate investment in property.

In relation to the property system 10 according to the first embodiment, the identification unit 120 identifies a feature, of a property, that is specified by the user, the property system 10 further includes the extraction unit 180 for extracting a property that satisfies the feature of a property, from properties in the first region and the second region, and the acquisition unit 140 acquires the first unit price information and the second unit price information about properties extracted by the extraction unit 180, and the first liquidity information and the second liquidity information about liquidity of the properties extracted by the extraction unit 180. Accordingly, the user may grasp the degree of influence of a feature of a property on the unit area price and the liquidity. Moreover, the user may make an investment in a property having a feature that may produce a higher yield.

The display processing unit 160 of the property system 10 according to the first embodiment causes the display unit 205a to display the first object in a honeycomb arrangement. The second regions may thus be tightly arranged in the comparison region. Furthermore, when zooming in or out on the comparison region displayed on the display unit 205a, the second region may be smoothly displayed, and a processing speed of a display process on the display unit 205a may be increased.

In relation to the property system 10 according to the second embodiment, the acquisition unit 140 acquires the unit price information and the liquidity information that are associated with each of a plurality of time points, and the display processing unit 160 causes the display unit 205a to display each the plurality of time points, the unit price information and the liquidity information in association with one another. Accordingly, the user may easily grasp how the unit area price and the liquidity are changed over time, by using the user terminal 200.

In relation to the property system 10 according to the second embodiment, the acquisition unit 140 acquires the unit price information and the liquidity information that are associated with each of a plurality of time points, and the display processing unit 160 causes the display unit 205a to display a second object indicating a relation between the unit price information and the liquidity information while changing a color of the second object according to a time point associated with the second object. Accordingly, the user may easily visually grasp how the unit area price and the liquidity are changed over time, by using the user terminal 200.

The display processing unit 160 of the property system 10 according to the second embodiment causes the display unit 205a to display a third object indicating the liquidity information in association with the unit price information, the third object indicating a degree of liquidity of a property using a size of an area shown in a color. Accordingly, the user may easily visually grasp the liquidity index of property. Furthermore, the user may easily grasp the liquidity index of property together with transition of the unit area price, and may thus make an appropriate investment in property.

In relation to the property system 10 according to the first to fourth embodiments, the unit area price of a property includes at least one of a sale price or a rent of the property per unit area. Accordingly, information about the price of a property per area may be obtained instead of the price of an individual property, and the user may thus easily grasp a good area for investing in property.

The property system 10 according to the third embodiment further includes the input unit 181 for inputting, to a learned model, information about a property including information indicating a location of a property and information about a purpose of a property, the learned model being learned by taking, as input data, information indicating a feature of a predetermined property in a predetermined region, information about the unit area price of the predetermined property, and information about the liquidity of the predetermined property, where the acquisition unit 140 acquires, from the learned model to which the information about a property is input, a first feature of a property that affects a price of the property, in relation to the location of a property and the purpose of a property. Accordingly, the user may easily grasp, by using the user terminal 200, what feature should be added to a property or what feature should be included when choosing a property in which to invest, at the time of making an investment in a property in a specific region.

In relation to the property system 10 according to the third embodiment, the acquisition unit 140 acquires a second feature that affects the price of a property that is a property including the first feature, in relation to the location of a property and the purpose of a property, and the display processing unit 160 causes the display unit 205a to display the first feature and the second feature in association with each other, in a form of a decision tree. Accordingly, the user may grasp the feature that affects the price of a property in the specified region, and may also grasp how much each feature affects the price of the property. Accordingly, the user may easily determine which feature to adopt, and may make an appropriate investment in property.

The property system 10 according to the fourth embodiment further includes the calculation unit 130 for calculating a first index based on the unit price information and the liquidity information at a first time point, and for calculating a second index based on the unit price information and the liquidity information at a second time point that is in future relative to the first time point, and the estimation unit 182 for estimating fluctuations in demand for property in the first region, based on a difference between the first index and the second index. Accordingly, the user may grasp a trend in the demand for property in the specified region, and make an appropriate investment in property.

### REFERENCE SIGNS LIST

B1, B2, B3 bus
N network
10 property system
100 server
200 user terminal
101, 201 control unit
102, 202 storage device

What is claimed is:

1. An information processing system comprising:
an identification unit for identifying a first region that is specified by a user;
an acquisition unit for acquiring first unit price information indicating a unit area price of a property in the first region, and first liquidity information indicating liquidity of the property; and
a display processing unit for causing a display unit to display the first unit price information and the first liquidity information in association with each other.

2. The information processing system according to claim 1, wherein
the acquisition unit acquires, in relation to a second region that is specified by the user, second unit price information indicating the unit area price of a property and second liquidity information indicating the liquidity of the property,
the information processing system further comprises a comparison generation unit for generating relative information indicating a result of relatively comparing the first unit price information and the first liquidity information with the second unit price information and the second liquidity information, and
the display processing unit causes the display unit to display a first object indicating the relative information.

3. The information processing system according to claim 2, wherein the display processing unit causes the display unit to display the first object while changing a color of the first object according to divergences between the first unit price information and the first liquidity information, and the second unit price information and the second liquidity information.

4. The information processing system according to claim 2 or 3, wherein
the identification unit identifies a feature, of a property, that is specified by the user,
the information processing system further comprises an extraction unit for extracting a property that satisfies the feature of a property, from properties in the first region and the second region, and
the acquisition unit acquires the first unit price information and the second unit price information about properties extracted by the extraction unit, and the first liquidity information and the second liquidity information about liquidity of the properties extracted by the extraction unit.

5. The information processing system according to claim 2, wherein the display processing unit causes the display unit to display the first object in a honeycomb arrangement.

6. The information processing system according to claim 1, wherein
the acquisition unit acquires the first unit price information and the first liquidity information that are associated with each of a plurality of time points, and
the display processing unit causes the display unit to display each the plurality of time points, the first unit price information and the first liquidity information in association with one another.

7. The information processing system according to claim 6, wherein
the acquisition unit acquires the first unit price information and the first liquidity information that are associated with each of a plurality of time points, and
the display processing unit causes the display unit to display a second object indicating a relation between the first unit price information and the first liquidity information while changing a color of the second object according to a time point associated with the second object.

8. The information processing system according to claim 6, wherein the display processing unit causes the display unit to display a third object indicating the first liquidity information, in association with the first unit price information, the third object indicating a degree of liquidity of a property using a size of an area shown in a color.

9. The information processing system according to claim 1, wherein the unit area price of a property includes at least one of a sale price or a rent of the property per unit area.

10. The information processing system according to claim 1, further comprising an input unit for inputting, to a learned model, information about a property including information indicating a location of a property and information about a purpose of a property, the learned model being learned by taking, as input data, information indicating a feature of a predetermined property in a predetermined region, information about the unit area price of the predetermined property, and information about the liquidity of the predetermined property, wherein
the acquisition unit acquires, from the learned model to which the information about a property is input, a first feature of a property that affects a price of the property, in relation to the location of a property and the purpose of a property.

11. The information processing system according to claim 10, wherein
the acquisition unit acquires, from the learned model to which the information about a property is input, a second feature that affects the price of a property that is a property including
the first feature, in relation to the location of a property and the purpose of a property, and the display processing unit causes the display unit to display the first feature and the second feature in association with each other, in a form of a decision tree.

12. The information processing system according to claim 1, further comprising:
a calculation unit for calculating a first index based on the first unit price information and the first liquidity information at a first time point, and for calculating a second index based on the first unit price information and the first liquidity information at a second time point that is in future relative to the first time point; and
an estimation unit for estimating fluctuations in demand for property in the first region, based on a difference between the first index and the second index.

13. An information processing method performed by a computer, the method comprising:
identifying a first region that is specified by a user;
acquiring first unit price information indicating a unit area price of a property in the first region, and first liquidity information indicating liquidity of the property; and
causing a display unit to display the first unit price information and the first liquidity information in association with each other.

14. A program for causing a computer to:
identify a first region that is specified by a user;
acquire first unit price information indicating a unit area price of a property in the first region, and first liquidity information indicating liquidity of the property; and
cause a display unit to display the first unit price information and the first liquidity information in association with each other.
